(19) United States
(12) Patent Application Publication
(10) Pub. No.: US 2021/0350484 A1
(43) Pub. Date: Nov. 11, 2021

(54) FRAMEWORKS FOR THE ANALYSIS OF INTANGIBLE ASSETS

(71) Applicant: AON RISK SERVICES, INC. OF MARYLAND, New York, NY (US)

(72) Inventors: Daniel Crouse, Seattle, WA (US); Lewis C. Lee, Atherton, CA (US); John E. Bradley, III, Duvall, WA (US)

(21) Appl. No.: 17/281,002

(22) PCT Filed: Oct. 1, 2018
(86) PCT No.: PCT/US18/53796

§ 371 Date: Mar. 29, 2021

(51) Int. Cl. G06Q 50/18

(52) U.S. Cl. CPC G06Q 50/184

(57) ABSTRACT

Techniques described herein are directed to analyzing intangible assets according to various frameworks. In particular implementations, an intangible assets evaluation service may obtain intellectual property data from a number of different sources and analyze the intellectual property data according to one or more frameworks. The intangible assets evaluation service may perform a qualitative analysis of intellectual property data. The qualitative analysis may be performed with respect to intellectual property data of an organization relative to intellectual property data for a number of other organizations. The intangible assets evaluation service may also perform a quantitative analysis of intellectual property data to determine a monetary valuation for a portfolio of intellectual property assets.

### CROSS REFERENCE TO RELATED APPLICATIONS

This application is a national stage application of international patent application PCT/US18/53796, filed Oct. 1, 2018, which is incorporated by reference herein.

### BACKGROUND

Analyzing data to provide meaningful information is not a trivial endeavor, particularly in situations where little to no previous analyses of certain data have been performed. It can be difficult to identify information that can be derived from data that has rarely been analyzed and it can also be challenging to determine which types of data can be utilized to make decisions. Additionally, there are challenges in identifying factors that can influence the analysis of particular types of data and that can be evaluated to provide meaningful information.

### BRIEF DESCRIPTION OF THE DRAWINGS

The above and other features of the present disclosure, its nature and various advantages, will be more apparent upon consideration of the following detailed description, taken in conjunction with the accompanying drawings in which:

FIG. 1 illustrates an example environment to analyze intellectual property data according to some implementations.

FIG. 2 illustrates an example system to analyze intellectual property data including a qualitative analysis and a quantitative analysis according to some implementations.

FIG. 3 illustrates an example system to perform a qualitative analysis and a quantitative analysis of patent data according to some implementations.

FIG. 4 illustrates an example system to perform a qualitative analysis and a quantitative analysis of trade secret data according to some implementations.

FIG. 5 illustrates an example user interface displaying results of a qualitative analysis of intellectual property data according to some implementations.

FIG. 6 illustrates an example user interface displaying results of a quantitative analysis of intellectual property data according to some implementations.

FIG. 8 illustrates an example process to perform a quantitative analysis of intellectual property data according to some implementations.

FIG. 9 illustrates an example process to perform a qualitative analysis and a quantitative analysis of intellectual property data according to some implementations.

FIG. 10 illustrates an example system to utilize various frameworks to analyze intellectual property data according to some implementations.

In the figures, the left-most digit(s) of a reference number identifies the figure in which the reference number first appears. The use of the same reference numbers in different figures indicates similar or identical items or features. Moreover, multiple instances of the same part are designated by a common prefix separated from the instance number by a dash. The drawings are not to scale.

### DETAILED DESCRIPTION

Techniques described herein are directed to generating frameworks for the evaluation of intangible assets and utilizing the frameworks to perform various analyses of intangible assets. Intangible assets may include intellectual property, contracts, human capital, and so forth. As technological advancement has increased, and the value of organizations has been characterized by the shift from tangible assets to intangible assets, the importance of intangible assets has also increased. Thus, organizations have taken various measures to safeguard their intangible assets. However, there have been few techniques and frameworks developed to analyze intangible assets and glean useful information from an organization's intangible assets. Accordingly, there is a lot of work to be done in identifying the types of intangible assets that can be analyzed and identifying the relevant factors and/or criteria that can be utilized to analyze intangible assets to provide information that may be useful to an organization. Additionally, organizations have begun to realize that intangible assets may provide value. Since intangible assets, such as intellectual property, have been recognized as an asset class for, at most, the last decade, few, if any, frameworks have been developed to analyze intangible assets for valuation purposes.

The implementations described herein are directed to techniques and systems to analyze intangible assets according to various frameworks. In particular implementations, an intangible asset evaluation service may obtain intangible asset data from a number of different sources and analyze the intangible asset data according to one or more frameworks. The intangible asset evaluation service may perform a qualitative analysis of intangible asset data. The qualitative analysis may be performed with respect to intangible asset data of an organization relative to intangible asset data for a number of other organizations. In some implementations, the intangible assets being evaluated may correspond to a particular industry or a particular technological area.

In illustrative implementations, a qualitative analysis of intellectual property data of an organization may be related to valuation of intellectual property assets of the organization. A qualitative analysis may be performed that determines an indicator of opportunity with respect to one or more intellectual property assets of the organization. Opportunity in relation to intellectual property may correspond to an indicator of the potential for increased value of an organization based on one or more intellectual property assets of the organization. Intellectual property assets may affect the opportunity of an organization based on a number of factors. For example, the potential geographic reach of intellectual property assets may be an indicator of the potential for increased value of the intellectual property assets and the organization. Additionally, market size and the industry where intellectual property assets may be applicable are other indicators of potential increased value of the organization. The potential scope of intellectual property assets may also correspond to an indicator of potential value of the organization.

The qualitative analysis for intellectual property of an organization may also include determining an indicator of risk for intellectual property assets of the organization. Risk may correspond to a probability that intellectual property assets might be rendered ineffective or less effective and may be an indicator for decreased value of the organization. For example, risk may correspond to a probability that the opportunity related to one or more intellectual property assets may not be realized. An amount of risk associated with intellectual property assets may be based on a probability or possibility that the intellectual property assets may be rendered unenforceable. To illustrate, for patents, risk may correspond to a probability that the patents may be invalidated, while for trade secrets, risk may correspond to a probability that the trade secrets may be misappropriated. Another factor indicating the amount of risk for intellectual property assets may relate to a probability of avoiding enforcement with respect to one or more intellectual property assets. In an illustrative example, with respect to patents, the ease of designing around claimed subject matter or the possibility of substituting non-infringing goods that function similarly to infringing goods are factors to consider in determining an amount of risk for patents.

A level of risk for the intellectual property of an organization may be reduced based on an evaluation of one or more mitigating factors. Mitigating factors with respect to risk may include a number of types of intellectual property that are included in a portfolio of an organization that cover aspects of one or more goods and/or services offered by the organization. For example, risk may be reduced for a good and/or service that is covered by utility patents, design patents, and copyrights. Additionally, an organization with a number of patents that exceeds one or more thresholds may also have a reduced risk associated with the intellectual property of the organization.

In addition, a qualitative analysis of intellectual property assets of an organization may include determining an amount of coverage of goods and/or services available in a market or industry that are associated with the intellectual property assets, which may alternatively be referred to as the current status of the intellectual property assets. For example, an amount of correlation between intellectual property of an organization and goods and/or services provided by the organization or others in a particular industry may be an indicator of coverage. To illustrate, a trademark may increase the value of an organization if it covers a relatively broad classification of goods and/or services provided by the organization. A patent may increase the value of an organization if the claims of the patent cover not only the goods and/or services provided by the organization, but also goods and/or services provided by other organizations. Coverage for intellectual property may also relate to a level of quality of one or more intellectual property assets such as a measure of the breadth and/or strength of intellectual property assets. Determining the breadth of intellectual property, such as patents, may include performing a semantic analysis of the claims and analyzing the words included in the claims of a patent with respect to words included in a particular dataset of similar patents. Strength of patents may be determined by evaluating factors, such as age of the patent, number of other patents that cite the patent, word count of shortest independent claim. These factors may be utilized to determine an indicator of strength of the patent with respect to the strength of other patents in a dataset.

Indicators of opportunity, risk, and/or coverage for intellectual property may be determined for individual intellectual property assets of an organization, for groups of intellectual property assets of an organization, or for both individual intellectual property assets and groups of intellectual property assets. In various implementations, measures of opportunity, risk, and/or coverage for individual intellectual property assets may be aggregated to determine overall measures of opportunity, risk, and/or coverage for a portfolio of intellectual property assets of an organization. In particular implementations, the measures of opportunity, risk, and/or coverage for individual intellectual property assets of a specified type of intellectual property, may be aggregated. For example, the measures of risk, opportunity, and/or coverage for a number of individual patent assets of an organization may be aggregated to determine overall measures of risk, opportunity, and/or coverage for the patent assets of the organization. Additionally, individual intellectual property assets may be analyzed with respect to other intellectual property assets within a particular industry to determine measures of opportunity, risk, and/or coverage. For example, trademarks of an organization may be analyzed with respect to opportunity, risk, and/or coverage in relation to trademarks of other organizations offering goods and/or services that are similar to the goods and/or services offered by the organization. In other scenarios, individual intellectual property assets may be analyzed in relation to opportunity, risk, and/or coverage with respect to a larger group of intellectual property assets of a particular type. To illustrate, patents of an organization may be analyzed for opportunity, risk, and/or coverage in relation to each patent issued by a particular jurisdiction, each patent issued by a particular jurisdiction over a period of time, or each patent issued by a particular group of jurisdictions over a period of time. Furthermore, indicators of coverage, opportunity, and/or risk may be determined across different types of intellectual property assets of an organization. In an illustrative example, one or more indicators may be determined for opportunity, risk, and/or coverage of the patents, copyrights, trade secrets, and trademarks of an organization.

In addition to a qualitative analysis of the intellectual property of an organization, implementations of the intangible asset evaluation service described herein may perform a quantitative analysis of the intellectual property of organizations. A quantitative analysis of intellectual property of an organization may produce one or more monetary values expressed in a particular currency, such as dollars or euros, corresponding to intellectual property assets of the organization. The quantitative analysis of intellectual property of an organization may correspond to a single intellectual property asset or a plurality of intellectual property assets included in a portfolio of the organization. In certain implementations, the quantitative analysis of the intellectual property of the organization may correspond to a particular type of intellectual property asset of the organization, such as a quantitative analysis of trade secrets of the organization, a quantitative analysis of copyrights of the organization, or a quantitative analysis of patents of the organization.

Various methodologies may be utilized to perform the quantitative analysis of intellectual property. For example, intellectual property of an organization may be analyzed based on a cost to replace a comparable portfolio of intellectual property. In another example, intellectual property of an organization may be analyzed based on value of a comparable intellectual property portfolio that has previously been commercialized in the marketplace. The comparable intellectual property portfolio may have been commercialized via a sale of the intellectual property portfolio, licensing of the intellectual property portfolio, and/or enforcement of the intellectual property portfolio in litigation or administrative proceedings. In another example, intellectual property of an organization may be analyzed based upon the income and/or profit that is generated or could be generated from the intellectual property. In various implementations, the quantitative analysis of intellectual property may generate a range of monetary values for an intellectual property portfolio for individual methodologies. To illustrate, the quantitative analysis of intellectual property may generate a minimum value, an average value, and a maximum value for an intellectual property portfolio.

Conventional systems and frameworks to analyze intellectual property data are mainly directed to analyzing patents, such as the number of patent application filings in a particular industry, the number of patent application filings in a particular technology, or a number of patent application filings for a particular organization. Additionally, conventional systems and frameworks to analyze intellectual property data may analyze the prosecution history of various patent applications, such as determining a number of events that take place with respect to one or more patent applications. Events that take place during prosecution of patent applications may include receipt of office actions, receipt of a notice of allowance, filing an information disclosure statement, and so forth. In certain instances, conventional systems and frameworks for analyzing intellectual property data may evaluate a strength and/or scope of claims of patents.

However, conventional systems and frameworks to analyze intangible assets, such as intellectual property, have not performed qualitative analyses and quantitative analyses to determine a valuation of intangible assets. Thus, the implementations and frameworks described herein are directed to performing analyses of intangible assets that are different from conventional systems and frameworks. Accordingly, implementations of systems and frameworks described herein have been developed to utilize sets of factors that correlate to valuations of intangible assets, such as intellectual property, and these factors are not evaluated with respect to intangible assets. Thus, the computer-implemented methods, systems, techniques, and frameworks described herein incorporate operations that are not performed by conventional systems that analyze intellectual property data. Additionally, since conventional techniques and systems are largely limited to the analyses of patents, the various implementations of the computer-implemented methods, systems, frameworks, and techniques described herein that have been developed for other classes of intellectual property implement operations that are not performed by conventional systems and methods.

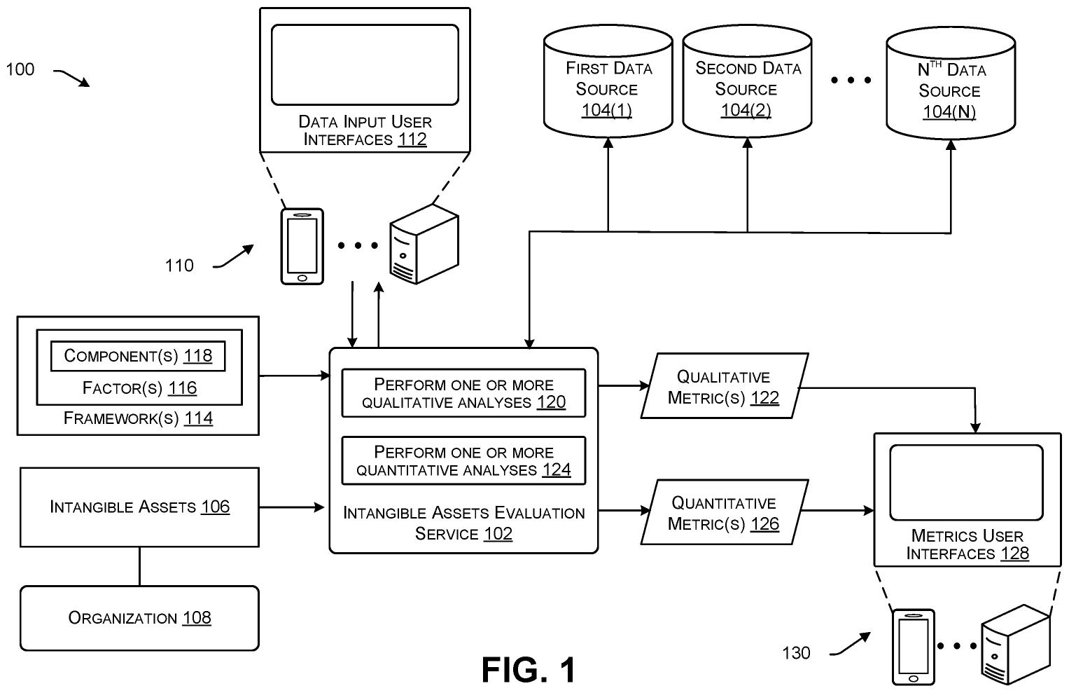

FIG. 1 illustrates an example environment 100 to analyze intangible assets according to some implementations. The environment 100 may include an intangible assets evaluation service 102. The intangible assets evaluation service 102 may be coupled to, include, or otherwise be associated with one or more data sources 104 to obtain data utilized to analyze one or more intangible assets 106. For example, the intangible assets evaluation service 102 may be coupled to or include a first data source 104(1), a second data source 104(2), up to an N^{th} data source 104(N). Additionally, the intangible assets 106 may include at least a portion of intangible assets associated with an organization 108. The organization 108 may include a company that offers goods and/or services to customers. In other situations, the organization 108 may include an entity that accumulates intangible assets from other organizations.

The intangible assets 106 may include all assets other than tangible assets including intellectual property, such as trade secrets, copyrights, patents, trademarks, know-how, as well as other assets such as contracts, human capital (e.g., other than know-how), and data (e.g., other than as protected by protected by IP), combinations thereof, and the like. Intangible assets may also be analyzed by resource types, e.g., data, software, and human capital, whose elements span or extend beyond particular types of IP. For example, software resources may be associated with patents, trademarks, copyrights, trade secrets, know how, contracts and human capital. Data may be associated with copyright, trade secret, contract and sui generis protection in select jurisdictions. The intangible assets 106 may be associated with various forms of documentation that indicate features of the intangible assets 106. In situations where the intangible assets 106 include patents, the patents may include utility patents, design patents, and/or plant patents. The patents may also include patent applications, such as provisional patent applications, utility patent applications, design patent applications, plant patent applications, or combinations thereof. In various scenarios, the intangible assets 106 may include trademark applications and granted trademarks. The intangible assets 106 may also include documentation corresponding to copyright registrations and documentation including aspects of trade secrets. To illustrate, formulas, processes, and/or algorithms and software code that are the subject of trade secrets may be documented. Actions taken to preserve the secrecy of trade secrets may also be documented and included in the intangible assets 106. In addition, the intangible assets 106 may include documentation of know-how of the organization 108, such as process improvements and innovations, new product designs, product improvements, brand names, logos, ad slogans, website design, product appearance, product packaging, manufacturing processes, engineering drawings, instruction manuals, product catalogs, customer and supplier lists, and so forth.

In certain implementations, the intangible assets 106 may be associated with one or more governmental entities. The one or more governmental entities may include at least one of a patent examining jurisdiction, a trademark examining jurisdiction, or a copyright repository. Further, the intangible assets 106 may be subject to laws of various governmental entities, such as the laws of one or more countries, the laws of one or more provinces, the laws of one or more states, or the laws of one or more enforcement entities. The data sources 104 may store data that corresponds to factors that correlate to valuations of the intangible assets 106.

In particular implementations, at least one of the data sources 104 may include patent application data for a jurisdiction that examines patent applications, such as the United States Patent and Trademark Office (USPTO) or the European Patent Office (EPO). Additionally, at least one of the data sources 108 may store data corresponding to products and/or services that are related to the intangible assets 106. To illustrate, a data source 104 may store specifications of products and/or services offered by the organization 108 that are associated with the intangible assets 106. In other examples, a data source 106 may store information extracted from webpages related to products and/or services offered by the organization 108. One or more data sources 104 may also store information associated with products and/or services offered by other organizations. Further, one or more of the data sources 104 may store information corresponding to litigation proceedings and/or other enforcement proceedings associated with intangible assets 106 of a number of organizations. In particular implementations, the information stored by the data sources 104 may be accessed by the intangible assets intangible assets evaluation service 102 via calls of one or more application programming interfaces (APIs) that enable the intangible assets intangible assets evaluation service 102 to parse and extract data from the data sources 104. In certain implementations, documentation related to the intangible assets intangible assets 106 may also be stored by at least one of the data stores 104.

Data stored by the data sources 104 related to organizations, including the organization 108, may be updated over time and accessed and/or retrieved by the intangible assets evaluation service 102. For example, as the composition of the intangibles assets of organizations change, the data stored by the data sources also changes. In an illustrative example, financial data related to organizations that is stored by the data sources 104 may be updated over time. In other examples, as prosecution history of patents and/or trademarks of organizations change and as various organizations file additional intellectual property assets with particular examining jurisdictions or repositories, the data stored by the data sources 104 may change over time. Additionally, as organizations develop additional trade secrets and know-how, the updated information may be stored by the data sources 104. Further, as human capital of organizations change over time, the information stored by the data stores 104 for the organizations may be modified to reflect the changes.

In additional implementations, the intangible assets intangible assets evaluation service 102 may obtain information corresponding to the intangible assets 106, information related to products and/or services offered by the organization 108, financial information associated with the organization 108, or combinations thereof, via one or more computing devices 110. In particular implementations, the computing devices 110 may display one or more data input user interfaces 112 that may include user interface elements that capture data related to the products and/or services offered by the organization 108 intangible assets 106. The user interface elements of the user interfaces 112 may be different based on the type of intangible assets 106 for which information is being captured. For example, the user interfaces 112 may include one set of user interface elements when capturing information about trademarks and another set of user interface elements when capturing information about copyrights. In various implementations, the user interfaces 112 may dynamically display user interface elements based on information input into additional user interface elements. To illustrate, in situations where a user interface element is populated with processes and/or formulas for trade secrets, additional user interface elements may be displayed to indicate or upload documentation supporting the secret status of the trade secrets, such as employee manuals describing confidentiality policies or non-disclosure agreements signed by entities that may have been exposed to details of the trade secrets. The implementation of dynamic user interface elements that are specific to capturing information about certain types of intellectual property is different from conventional systems that simply generate user interfaces associated with capturing information about a single type of intangible assets, namely patents.

The intangible assets evaluation service 102 may analyze data stored by the data sources 106 or obtained via the user interfaces 112 with respect to the intangible assets intangible assets 106. The intangible assets 106 being analyzed may include one or more types of intellectual property identified by the intangible assets evaluation service 102. For example, the intangible assets evaluation service 102 may analyze trade secrets of the organization 108 or patents of the organization 108. In additional examples, the intangible assets 106 being analyzed may be directed to a particular technological field or to one or more products or services offered by the organization 108.

After identifying a group of the intangible assets 106 to be analyzed, the intangible assets evaluation service 102 may determine a framework 114 by which intangible assets 106 are to be analyzed. In particular implementations, frameworks utilized to analyze intangible assets may include a number of factors 116 that are indicative of value of intangible assets. Individual factors 116 may also include one or more components 118 that may be utilized to determine valuations for the intangible assets 106. The components 118 may be sub-factors that each include separate criteria that may be evaluated to determine metrics for the individual factors 116. Additionally, the components 118 for individual factors 116 of a framework 114 used to evaluate the intangible assets 106 may be weighted. In certain implementations, the individual components 118 for individual factors 116 of the framework 114 may be weighted differently. In some implementations, the weighting of the components 118 may be based on the information utilized to determine metrics for the individual components 118. For example, information that directly corresponds to determining a metric for a component 118 may be weighted more heavily than information that indirectly may be utilized to determine a metric for the component 118. To illustrate, utilizing results of litigation that involved the organization 108 to determine risk may be weighted more heavily that data indicating a general amount of litigation within a particular industry.

In certain implementations, a plurality of previously performed analyses of intangible assets may be evaluated to identify the factors 116 that indicate value of intangible assets. In various implementations, the previously performed analyses may comprise a corpus of data that is processed according to one or more machine learning algorithms to identify factors that correspond to value of intangible assets. The factors 116 included in frameworks 114 to analyze intangible assets data may be based on a type of intangible assets being analyzed. For example, a framework 114 to analyze know-how may include a first set of factors and a framework 114 to evaluate copyrights may include a second set of factors where at least one of the factors included in the second set of factors is different from the first set of factors. In additional implementations, the frameworks 114 may include a common set of factors 116 that may be analyzed for a number of different types of intangible assets. In an illustrative example, a single framework 116 may be utilized to analyze patents, trademarks, copyrights, and trade secrets.

Additionally, factors 116 included in a framework 114 utilized to analyze the intangible assets 106 may be based on a technical area associated with the intangible assets 106 or on one or more types of products or services offered by the organization 108 that correspond to the intangible assets 106. In particular implementations, individual frameworks 114 used to analyze intangible assets associated with different technical areas may include different factors 116. Further, individual frameworks 114 utilized to analyze intangible assets corresponding to different types of products or services may also include different factors 116. That is, a framework utilized to evaluate intangible assets of pharmaceutical products may include at least one factor that is different from a framework utilized to evaluate intangible assets of virtual reality headsets. In other situations, certain frameworks 114 may include a number of factors 116 that are commonly applicable to a broad range of technical areas, products, and services.

The intangible assets evaluation service 102 may obtain data from the data sources 106 and/or obtain data via the user interfaces 112 based at least partly on the factors 116 included in the framework 114 selected to evaluate the intangible assets 106. In illustrative implementations, the intangible assets evaluation service 102 may determine that the framework 114 to evaluate the intangible assets 106 includes a factor 116 corresponding to a market size for a product corresponding to the intangible assets 106. Accordingly, the intangible assets evaluation service 102 may parse the data sources 104 for market research associated with the product. In particular implementations, the intangible assets evaluation service 102 may determine keywords to associate with individual factors 116 included in frameworks 114 utilized to evaluate intangible assets. For example, the intangible assets evaluation service 102 may determine that a first set of keywords may be used to identify information corresponding to market-based information for products, while a second set of keywords may be used to identify information corresponding to litigation verdicts. In additional implementations, the intangible assets evaluation service 102 may determine that information corresponding to certain factors 116 of a framework 114 may be obtained from particular data sources 104. To illustrate, the intangible assets evaluation service 102 may determine that patent prosecution history information may be obtained from the first data source 104(1) and that copyright registration information may be obtained from the second data source 104(2). In some implementations, the retrieval of data from the data sources 104 may be automated and performed by web crawlers or other information retrieval algorithms. In other implementations, at least some of the data retrieved from the data sources 104 may be obtained manually by representatives of the intangible assets evaluation service 102.

In various implementations, the intangible assets evaluation service 102 may store data obtained from the data sources 104 according to one or more formats and/or one or more schemas. In particular, the intangible assets evaluation service 102 may store data relating to factors 116 included in frameworks 114 used to evaluate in such a way that the data may be retrieved and processed efficiently by the intangible assets evaluation service 102 and with the use of a minimum number of computing resources of the intangible assets evaluation service 102. For example, the intangible assets evaluation service 102 may store data obtained from the data sources 104 in according to a comma separated values (CSV) format to improve the efficiency of the processing and retrieval of the data as opposed to storing the data in other formats, such as an Excel format or an extensible markup language (XML) format. Additionally, the intangible assets evaluation service 102 may store data obtained from the data sources 106 according to one or more tags that correspond to factors 116 included in frameworks 114 used to analyze intangible assets. To illustrate, the intangible assets evaluation service 102 may store descriptions of goods and/or services for trademarks according to one or more first tags and non-disclosure agreements related to trade secrets according to one or more second tags. The tags associated with data may be utilized by the intangible assets evaluation service 102 to efficiently identify and retrieve data that corresponds to certain factors 116 included in the frameworks 114 utilized to analyze intangible assets. In this way, the intangible assets evaluation service 102 may perform analyses of intangible assets using fewer computing resources and/or using fewer processing cycles than systems that do not implement the data storage and retrieval schemas implemented by the intangible assets evaluation service 102.

After the intangible assets evaluation service 102 has identified and obtained data corresponding to factors 116 included in a framework 114 to evaluate the intangible assets 106, the intangible assets evaluation service 102 may, at 120, perform one or more qualitative analyses of the intangible assets 106. The qualitative analyses may generate qualitative metrics 122 for the factors 116 being analyzed. The qualitative metrics 122 may be a relative measure with respect to a scale. In certain implementations, the intangible assets evaluation service 102 may determine a metric for each component 118 included in a factor 116 corresponding to an opportunity associated with the intangible assets 106. In these situations, an overall opportunity metric for the intangible assets 106 may be determined by aggregating the metrics for each individual component 118 included in a framework used to evaluate opportunity of the intangible assets 106.

In particular implementations, the intangible assets evaluation service 102 may analyze opportunity with respect to the intangible assets 106. Opportunity may correspond to a potential for the intangible assets 106 to provide an increase in value to the organization 108. Evaluating the opportunity of the intangible assets 106 may include analyzing data associated with various components of the opportunity factor, such as the industry and market size corresponding to products and/or services related to the intangible assets 106, potential for licensing the intellectual property assets, and the intangible assets 106 being applicable to products and/or services outside of the current products and/or services associated with the intangible assets 106.

The intangible assets evaluation service 102 may analyze the components 118 related to the opportunity factor for the intangible assets 106 with data corresponding to the individual components 118 in order to determine an opportunity metric for the intangible assets 106. The opportunity metric may indicate an amount of potential for the intangible assets 106 to add value to the organization 108. The opportunity of the intangible assets 106 may be measured relative to additional intangible assets of additional organizations. The additional intangible assets may be related to an industry that is similar to an industry associated with the intangible assets 106 or related to a technical area that is similar to a technical area associated with the intangible assets 106. In various implementations, the additional intellectual property assets that the intangible assets 106 are evaluated against may be semantically similar. In a particular example, the opportunity metric for the intangible assets 106 may be characterized along a scale from limited opportunity to expansive opportunity.

The qualitative analyses performed by the intangible assets evaluation service 102 may also include determining a metric for a risk factor corresponding to the intangible assets 106. Risk may indicate a potential for the organization 108 not to realize the opportunity associated with the intangible assets 106. In particular implementations, risk may indicate a probability that one or more of the intangible assets 106 may be rendered ineffective or less effective and may be an indicator for decreased value of the organization 106. For example, risk may indicate a probability that one or more patents included in the intangible assets 106 may be invalidated. In another example, risk may indicate a probability that one more trade secrets included in the intangible assets 106 may be misappropriated resulting in a loss of the secret/confidential status of the one or more trade secrets.

Additionally, the qualitative analyses performed by the intangible assets evaluation service 102 may include determining coverage of the intangible assets 106. Coverage may correspond to a measure of protection provided by the intangible assets 106 for goods and/or services offered in the marketplace. In particular, coverage may also be referred to as the current status of the intangible assets 106. In certain implementations, coverage may correspond to a measure of the assets' coverage of goods and/or services offered by the organization 108, a measure of coverage of goods and/or services offered by other organizations, or both. In illustrative examples, coverage may correspond to a number of goods and/or services covered by one or more trademarks included in the intangible assets 106. In other examples, coverage may correspond to a number of goods and/or services covered by one or more patents included in the intangible assets 10.

The intangible assets evaluation service 102 may also, at 124, perform one or more quantitative analyses with respect to the intangible assets 106. The one or more quantitative analyses may produce one or more quantitative metrics 126. Additionally, in certain implementations, the quantitative analyses performed by the intangible assets evaluation service 102 with respect to the intangible assets 106 may be based at least partly on one or more metrics generated by one or more qualitative analyses of the intangible assets 106. In particular implementations, the one or more quantitative analyses may be related to monetary valuations of the intangible assets 106. In these situations, the one or more quantitative metrics 126 may include one or more values of the intangible assets 106 expressed in one or more currencies. In certain implementations, the one or more quantitative metrics 126 may be expressed within a scale or within a range of monetary values. A number of methodologies may be utilized by the intangible assets evaluation service 102 to perform the quantitative analyses. In some situations, the quantitative metrics 126 may include individual metrics for each methodology utilized by the intangible assets evaluation service 102. Further, the intangible assets evaluation service 102 may perform the quantitative analyses with respect to one or more scenarios that may cause value to be associated with the intangible assets 106. In some examples, the intangible assets evaluation service 102 may perform the quantitative analyses with respect to a liquidation scenario where the organization 108 is terminated and the intangible assets 106 are sold. In additional examples, the intangible assets evaluation service 102 may perform quantitative analyses with respect to a going concern value related to the revenue provided to the organization 108 by products and/or services associated with the intangible assets 106. The analyses related to revenue may consider revenue or income without cost, revenue and cost, and/or profit, with various other considerations, such as interest, tax and depreciation considered or excluded from the analysis. In further examples, the intangible assets evaluation service 102 may perform quantitative analyses with respect to revenue of additional organizations that offer goods and/or services that are similar to goods and/or services associated with the intangible assets 106.

In various implementations, the qualitative metrics 122 and the quantitative metrics 126 may be displayed via one or more metrics user interfaces 128. The one or more metrics user interfaces 128 may be generated by the intangible assets evaluation service 102 and displayed using computing devices 130. In particular implementations, the one or more metrics user interfaces 128 may include one or more of the qualitative metrics 122 shown in relation to a scale. Additionally, the one or more metrics user interfaces 128 may include one or more quantitative metrics 126 shown in relation to a scale.

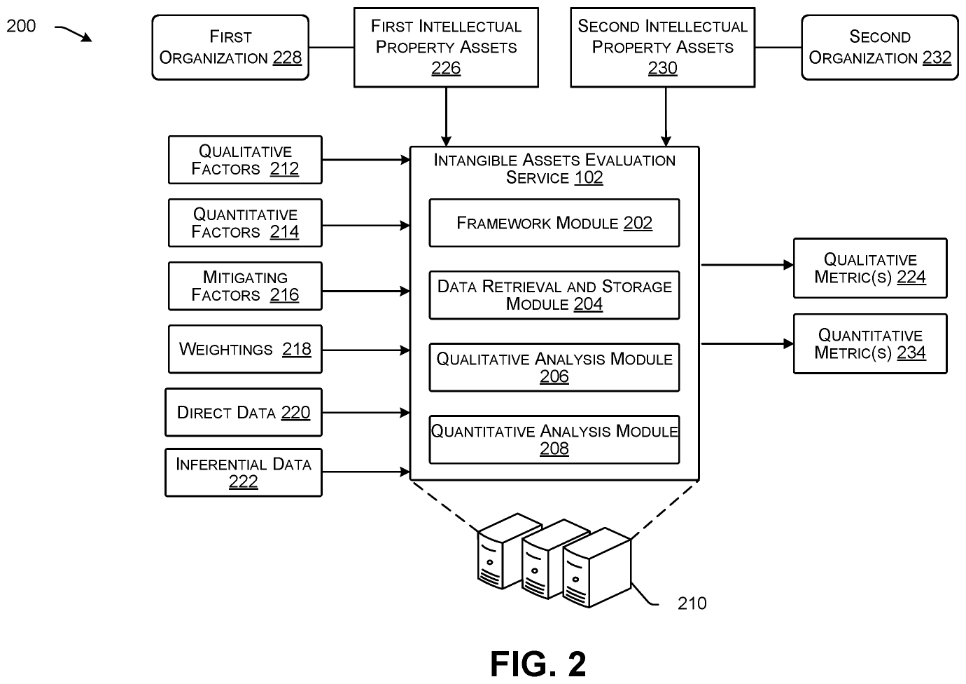

FIG. 2 illustrates an example system 200 to analyze intellectual property data including a qualitative analysis and a quantitative analysis according to some implementations. The system 200 may include the intangible assets evaluation service 102. Additionally, although not shown in the illustrative implementation of FIG. 2, the intangible assets evaluation service 102 may be in communication with the data sources 104 of FIG. 1. The intangible assets evaluation service 102 may include a number of modules that include computer-readable instructions that may be executable to perform operations directed to performing qualitative analyses and quantitative analyses of intellectual property. In particular, the intangible assets evaluation service 102 includes a framework module 202, a data retrieval and storage module 204, a qualitative analysis module 206, and a quantitative analysis module 208.

In the illustrative implementation of FIG. 2, the intangible assets evaluation service 102 may be implemented by one or more servers 210. The one or more servers 210 can be included in a cloud computing architecture that operates the one or more servers 210 on behalf of the intangible assets evaluation service 102. In these scenarios, the cloud computing architecture may implement one or more virtual machine instances on behalf of the intangible assets evaluation service 102 on the one or more servers 210. The cloud computing architecture may be located remotely from the intangible assets evaluation service 102. In additional implementations, the one or more servers 210 can be under the direct control of the intangible assets evaluation service 102. For example, the intangible assets evaluation service 102 may maintain the one or more servers 210 in one or more geographic locations to perform operations related to analyzing intellectual property data. In particular, the one or more servers 210 may execute operations directed to performing qualitative analyses and quantitative analyses of intellectual property data.

In various implementations, the framework module 202 may include computer-readable instructions that are executable to generate frameworks for the evaluation of intellectual property data, such as the frameworks 114 of FIG. 1. The frameworks may include a number of factors, such as qualitative factors 212 that may be evaluated with respect to the analysis of intellectual property. The qualitative factors 212 may include opportunity, risk, and coverage. The frameworks may also include quantitative factors 214 related to determining monetary valuations for intellectual property. The factors 212, 214 included in the frameworks may be based on type of intellectual property being evaluated, technical area(s) associated with the intellectual property being evaluated, or both. The factors 212, 214 included in the frameworks may also be associated with certain types of data that may be utilized in the analysis of intellectual property. That is, the analysis of particular types of data, such as active litigation data or patent prosecution history data, may be utilized to determine a metric for a respective factor, such as risk or coverage. The frameworks may also include mitigating factors 216 that may modify the metrics determined for one or more factors included in a framework. For example, a risk metric may be reduced based on a size of a patent portfolio of an organization. That is, a larger patent portfolio may reduce the risk associated with possible litigation in relation to intellectual property. The frameworks may also include weightings 218 that may be applied to factors utilized to evaluate intellectual property. The weightings 218 may indicate an amount of impact that a particular factor has on valuation of intellectual property. Additionally, components associated with individual factors may also have weightings 218. In an illustrative example, a component of a risk factor related to the potential to invalidate a patent may have a higher weighting than a component of the risk factor associated with the impact of case law on the patent. In certain implementations, the weightings 218 may be based at least partly on a type of intellectual property being evaluated.

In particular implementations, the framework module 202 may obtain data via one or more user interfaces corresponding to one or more factors that are included in a framework. For example, associations between certain types of data and factors of the frameworks may be captured via one or more user interfaces. In this way, representatives of the intangible assets evaluation service 102 may develop new frameworks or modify existing frameworks by entering factors, components of the factors, and data utilized to evaluate the factors.

The data retrieval and storage module 204 may include instructions that are executable to retrieve and store data utilized by the intangible assets evaluation service 102 in analyzing intellectual property. The data obtained by the data retrieval and storage module 204 may be retrieved from one or more data sources, such as the data sources 106 of FIG. 1. The data retrieval and storage module 204 may store data obtained from one or more data sources according to one or more particular schemes. Additionally, the data retrieval and storage module 204 may store data obtained from one or more data sources according to one or more formats, such as a CSV format.

The data retrieval and storage module 204 may classify at least a portion of the data obtained from data sources as either direct data 220 or inferential data 222. Direct data 220 may be utilized to directly evaluate a valuation factor of intellectual property. For example, direct data 220 may indicate licensing value of a current intellectual property asset of an organization that may be utilized to determine a numerical valuation for the intellectual property of the organization. In another example, litigation that involves an intellectual property asset of an organization may be direct evidence of risk of invalidation of the intellectual property asset. Inferential data 222 may include data that may be utilized to infer a metric for a particular valuation factor. To illustrate, inferential data 222 may include a number of owners of intellectual property assets in a given industry or amount of non-practicing entity ownership in a given industry, which may be utilized to infer a risk of litigation with respect to intellectual property assets of an organization in the given industry. In various implementations, factors that are evaluated using direct data 220 may be weighted more heavily than factors that are evaluated using inferential data 222.

The qualitative analysis module 206 may include instructions that are executable to perform a qualitative analysis of the valuation of intellectual property. The qualitative analysis may not generate a numerical valuation for intellectual property, but may generate qualitative metrics 224 for other characteristics of the value of intellectual property, such as opportunity, risk, and/or coverage. In an illustrative implementation, the qualitative analysis module 206 may analyze first intellectual property assets 226 of a first organization 228. In particular implementations, the framework module 202 may generate or obtain one or more frameworks that correspond to the first intellectual property assets 226. The framework module 202 may determine the framework to analyze the first intellectual property assets 226 based on one or more types of intellectual property included in the first intellectual property assets 226. The qualitative analysis module 206 may identify individual factors included in the framework and determine types of data that may be utilized to evaluate the factors. The qualitative analysis module 206 may then retrieve the data needed to evaluate the individual factors included in the framework. The qualitative analysis module 206 may apply the data corresponding to each factor and/or the components associated with each factor and determine a metric for the individual factors based on the data applied with respect to the factor and weightings associated with the data. In various implementations, the metrics generated for individual factors may be determined according to one or more models that may correspond to the factor.

In certain implementations, the qualitative metrics 224 may be determined by comparing data corresponding to the first intellectual property assets 226 with data corresponding to intellectual property assets of one or more additional organizations, such as second intellectual property assets 230 associated with a second organization 232. In particular implementations, the additional organizations may be included in the same or a similar industry as the organization 226. In additional implementations, the additional organizations may be associated with intellectual property assets that are similar to the first intellectual property assets 226. For example, the second intellectual property assets 230 may have at least a threshold amount of semantic similarity with respect to the first intellectual property assets 226.

Characteristics of intellectual property assets of other organizations may provide context for characteristics of the first intellectual property assets 226. That is, the context provided by intellectual property assets of other organizations may be utilized to determine the qualitative metrics 224 for the first intellectual property assets 226. In some examples, a component associated with strength and included in a framework may correspond to a strength of patents included in the first intellectual property assets 226 where the strength is utilized to determine coverage of the patents included in the first intellectual property assets 226. A qualitative metric 224 associated with the strength of the patents of the first intellectual property assets 226 may be determined by comparing the strength of the patents included in the first intellectual property assets 226 with the strength of at least the patents included in the second intellectual property assets 230. In particular implementations, based on a difference between a strength of the patents included in the first intellectual property assets 226 and the strength of other patents included in the intellectual property assets of other organizations, the qualitative analysis module 206 may determine a qualitative metric 224 for strength of the patents included in the first intellectual property assets 226. In situations where the strength of the patents of the first intellectual property assets 226 is greater than an average strength of patents of the other organizations by at least a threshold amount, the qualitative analysis module 206 may determine that a qualitative metric 224 for strength is at a higher end of a scale for the qualitative metric 224 corresponding to patent strength. Further, in scenarios where the strength of the patents of the first intellectual property assets 226 is lower than an average strength of patents of the other organizations by at least a threshold amount, the qualitative analysis module 206 may determine that the qualitative metric 224 for the strength of the patents of the first intellectual property assets 226 is on a lower end of a scale for the qualitative metric 224 corresponding to patent strength.

In other implementations, an amount of risk associated with the first intellectual property assets 226 may be determined based upon an amount of revenue and/or profit of the first organization 228 relative to the amount of revenue and/or profit of additional organizations, such as the second organization 232. In particular, as the revenue and/or profit of the first organization 228 increases, the likelihood of litigation regarding the intellectual property of the first organization 228 may increase. Thus, in situations where the first organization 228 has a revenue and/or profit that is greater than an average revenue and/or profit of the other organizations, such as the second organization 232, the qualitative analysis module 206 may determine that the qualitative metric 224 related to likelihood of litigation is on a higher end of a scale for the qualitative metric 224. Further, in situations where the first organization 228 has a revenue and/or profit that is less than an average revenue and/or profit of other organizations, the qualitative analysis module 206 may determine that the qualitative metric 224 related to likelihood of litigation is on a lower end of a scale for the qualitative metric 224.

The quantitative analysis module 208 may include computer-readable instructions executable to determine one or more quantitative metrics 234 for the first intellectual property assets 226. The quantitative metrics 234 may indicate a monetary valuation for the first intellectual property assets 226. The quantitative analysis module 208 may determine one or more methodologies to utilize to generate the one or more quantitative metrics 234 and retrieve data that may be utilized to implement at least one of the methodologies. For example, to implement a cost related methodology related to the liquidation value of the first intellectual property assets 226, the quantitative analysis module 208 may obtain data corresponding to the costs of reproducing the first intellectual property assets 226 including research and development costs attributable to the first intellectual property assets 226, other costs internal to the first organization 228 to develop the first intellectual property assets 226, and costs incurred with respect to organizations outside of the first organization 228, such as consultant fees, attorney fees, and governmental fees. The quantitative analysis module 208 may also compare the expenses of the first organization 228 utilized to produce the first intellectual property assets 226 to costs incurred by one or more of additional organizations, such as the second organization 232, in producing their respective portfolios, such as the costs to produce the second intellectual property assets 232. The quantitative analysis module 208 may utilize the cost data associated with producing the first intellectual property assets 226 and at least a portion of the cost data associated with producing the second intellectual property assets 232 to determine a quantitative metric 234 that corresponds to a monetary valuation of the first intellectual property assets 226. In particular implementations, the quantitative analysis module 208 may determine the quantitative metrics 234 based at least partly on a model that may be utilized to generate monetary valuations for intellectual property assets.

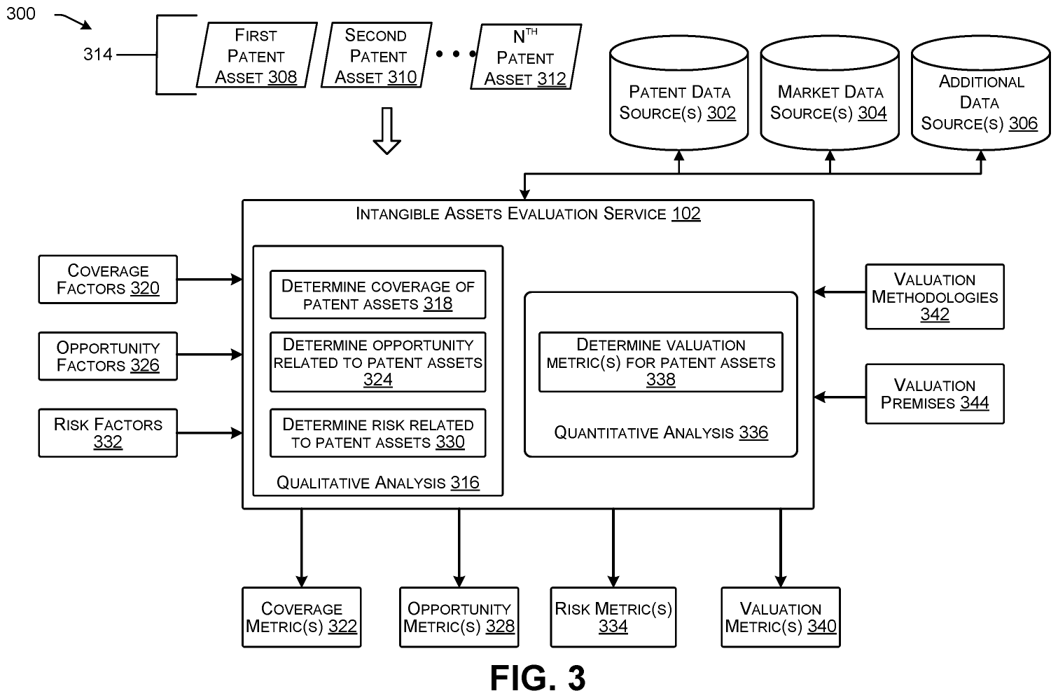

FIG. 3 illustrates an example system 300 to perform a qualitative analysis and a quantitative analysis of patent data according to some implementations. Although the illustrative implementations of FIG. 3 are directed to the analysis of patent data, in additional implementations, the system 300 may be adapted for other types of intangible assets, such as other types of intellectual property, contractual obligations, lines of business, combinations thereof, and so forth. The system 300 includes the intangible assets evaluation service 102. The intangible assets evaluation service 102 may be coupled to or otherwise in electronic communication with one or more patent data sources 302, one or more market data sources 304, and one or more additional data sources 306. The intangible assets evaluation service 102 may retrieve data from the data sources 302, 304, 306 to determine perform qualitative analyses and quantitative analyses of patent assets to determine qualitative metrics and quantitative metrics with respect to patent assets. The one or more patent data sources 302 may store information about issued patents, pending patent applications, and abandoned patent applications from one or more patent examining jurisdictions. The one or more patent data sources 302 may also include data related to patent litigation proceedings and data related to administrative hearings associated with patents and patent applications, such as appeals and inter partes review proceedings. The one or more patent data sources 302 may also store data related to freedom to operate analyses, patentability analyses, and/or infringement analyses performed with respect to patent assets. The one or more market data sources 304 may store data related to products and/or services offered by organizations and markets where the products and/or services are offered. The one or more market data sources 304 may also store financial information related to organizations that offer various products and/or services. The one or more additional data sources 308 may store additional data utilized by the intangible assets evaluation service 102 to perform qualitative and quantitative analyses of patent assets. For example, the one or more additional data sources 306 may store marketing and business information of organizations that procure patent assets and employee and/or inventor information for organizations that procure patent assets. In some implementations, the one or more additional data sources 306 may include data stores of one or more organizations that are accessible to the intangible assets evaluation service 102. Further, in particular implementations, at least a portion of the data stored by the one or more additional data sources 306 may be obtained by the intangible assets evaluation service 102 from one or more organizations that procure patent assets. Finally, in particular implementations, at least a portion of the data stored by the one or more additional data sources 306 may be obtained from the intangible assets evaluation service 102 as a result of prior analysis.

In the illustrative example of FIG. 3, the intangible assets evaluation service 102 may analyze a number of patent assets, such as the first patent asset 308, the second patent asset 310, up to an Nth patent asset 312. The patent assets 308, 310, 312 may comprise a patent portfolio 314 of an organization. In certain implementations, the intangible assets evaluation service 102 may analyze at least a portion of the claims of the patent assets 308, 310, 312. In particular implementations, the intangible assets evaluation service 102 may perform a qualitative analysis 316 with respect to at least a portion of the patent portfolio 314 that includes, at 318, determining a coverage or current status of the patent portfolio 314. Determining the coverage of the patent portfolio 314 may include evaluating one or more coverage factors 320 with respect to the patent portfolio 314. The intangible assets evaluation service 102 may perform the qualitative analysis 316 by obtaining data from the data sources 302, 304, 306. The data obtained from the data sources 302, 304, 306 may include a business plan of an organization that is associated with the patent portfolio 314, a marketing strategy of the organization, and information related to product and/or service offerings by the organization. The intangible assets evaluation service 102 may also obtain additional data from the data sources 302, 304, 306, such as research and development costs and intellectual property costs. The intellectual property costs may include expenses incurred by an organization to obtain the patent portfolio 314. Further, the intangible assets evaluation service 102 may obtain data related to present markets where goods and/or services of the organization are offered, future markets where the goods and/or services of the organization are expected to be offered, known competitors of the organization, potential competitors of the organization, financial data of the organization, financial forecasts of the organization, information related to employees of the organization (e.g., employee agreements, intellectual property assignments, etc.), and information regarding any ongoing or past legal disputes related to intellectual property of the organization.

In various implementations, the intangible assets evaluation service 102 may perform a number of operations to prepare the patent portfolio 314 for qualitative analyses and quantitative analyses. For example, the intangible assets evaluation service 102 may obtain the specification, including the claims, drawings, and patent prosecution history of the patent portfolio 314 from the one or more patent data sources 302. The intangible assets evaluation service 102 may also identify any assets in the patent portfolio 314 that have expired. Additionally, the intangible assets evaluation service 102 may format the data associated with the patent portfolio 314 according to a CSV format. In particular, the intangible assets evaluation service 102 may format data of the patent portfolio 314 such that the data in the columns of the CSV files may be retrieved and processed efficiently by the intangible assets evaluation service 102.

In certain implementations, a semantic analysis of the patent portfolio 314 may be performed. In various implementations, the intangible assets evaluation service 102 may analyze the patent portfolio 314 to determine one or more words included in the patent portfolio 314 and/or one or more phrases included in the patent portfolio 314. In particular implementations, the intangible assets evaluation service 102 may identify patent assets of other organizations that have at least a threshold semantic similarity with respect to one or more of the patent assets of the patent portfolio 314. The intangible assets evaluation service 102 may also generate a landscape of patent assets that include at least one patent asset of the patent portfolio 314 and additional patent assets of other organizations that have at least a threshold semantic similarity. The amount of semantic similarity between patent assets may correspond to a number of a set of words that match between patent assets and/or a number of one or more phrases that match between patent assets. In additional implementations, the intangible assets evaluation service 102 may determine clusters of semantically similar patent assets based on technology areas related to the patent assets.

The intangible assets evaluation service 102 may determine coverage for the patent portfolio 314 by determining a metric for a breadth component for the patent portfolio 314. The breadth component may be included in the coverage factors 320. The breadth component may be determined by performing a linguistic analysis of at least one claim of the patent portfolio 314 and additional patent assets included in a same technological area as the patent portfolio 314 and that have at least a threshold semantic similarity with the claim of the patent portfolio 314. The breadth component for each patent asset of the technological area that is analyzed may be normalized such that the number of patent assets having a particular breadth are evenly distributed. In particular implementations, the breadth component for patent assets may be on a scale, such as a scale from 1 to 100.

The intangible assets evaluation service 102 may also determine the coverage of the patent portfolio 314 by determining a strength component for the patent portfolio 314. The strength component may be included in the coverage factors 320. The strength component for the patent portfolio 314 may be determined by analyzing various data associated with the patent portfolio 314, such as a time remaining on patent term of one or more patent assets of the patent portfolio 314, a word count of the shortest independent claim of one or more patent assets of the patent portfolio 314, a number of additional patent assets that cite one or more patent assets of the patent portfolio 314 during their prosecution, a number of patent assets cited in the prosecution of one or more patent assets of the patent portfolio 314, a length of prosecution of one or more patent assets of the patent portfolio 314, a jurisdiction of one or more patent assets of the patent portfolio 314, and so forth. In particular implementations, the strength metric for the patent portfolio 314 may be determined relative to the strength metric for additional patent assets. The additional patent assets may be included in a same technical area as the patent portfolio 314 and/or may have at least a threshold amount of semantic similarity with respect to one or more patent assets of the patent portfolio 314. In other implementations, the strength metric for the patent portfolio 314 may be determined relative to a larger set of patent assets, such as all patent assets included in the one or more patent data sources 302 or all patent assets of a particular jurisdiction.

The intangible assets evaluation service 102 may also determine coverage of the patent portfolio 314 by determining a mapping between one or more patent assets of the patent portfolio 314 and products offered by the organization that developed the patent portfolio 314, components of products offered by the organization, services offered by the organization, or combinations thereof. In particular implementations, elements of claims of one or more patent assets of the patent portfolio 314 may be mapped to a portion of a product and/or service offered by the organization. The mapping of the one or more patent assets of the patent portfolio 314 to one or more goods and/or services may be one of the coverage factors 320. Another coverage factor 320 evaluated by the intangible assets evaluation service 102 to determine a coverage of the patent portfolio 314 may include an amount of coverage of goods and/or services offered by other organization with respect to claims of one or more patent assets of the patent portfolio 314. In various implementations, the intangible assets evaluation service 102 may compare elements of the claims of one or more patent assets of the patent portfolio 314 with features of products and/or services offered by a number of additional organizations. In certain implementations, marketing materials, product specifications, and the like may be analyzed by the intangible assets evaluation service 102 to identify features of products and/or services that may be mapped to elements of the claims of one or more patent assets of the patent portfolio 314.

After evaluating the coverage factors 320 with respect to the patent portfolio 314, the intangible assets evaluation service 102 may determine one or more coverage metrics 322 for the patent portfolio 314. In particular implementations, the intangible assets evaluation service 102 may determine a coverage metric 322 that is along a scale indicating an amount of coverage of the patent portfolio 314. In an illustrative example, the intangible assets evaluation service 102 may determine a coverage metric 322 along a scale from poor to good.

At 324, the intangible assets evaluation service 102 may determine a valuation characteristic relating to opportunity with respect to the patent portfolio 314. In various implementations, the intangible assets evaluation service 102 may determine an opportunity with respect to the patent portfolio 314 based on analyzing a number of opportunity factors 326 in relation to data associated with the patent portfolio 314. The opportunity factors 326 may include a market size and growth component and the intangible assets evaluation service 102 may determine a metric for the market size and growth component by identifying markets associated with products and/or services associated with the patent portfolio 314. The intangible assets evaluation service 102 may determine a size of the markets related to the products and/or services associated with the patent portfolio 314 by analyzing financial data and determining revenue generated through sales of the goods and/or services in included in the particular market.

The opportunity factors 326 may also include an alignment component that relates to an extent that the patent portfolio 314 corresponds to business strategies and activities of an organization that developed the patent portfolio 314. In certain implementations, the intangible assets evaluation service 102 may determine an extent that the patent portfolio 314 corresponds to existing products and/or services offered by the organization in addition to an extent that the patent portfolio 314 corresponds to products and/or services that the organization is planning to offer.

Additionally, the opportunity factors 326 may include a coverage footprint component that relates to a number of the assets in the patent portfolio 314 that are included in a landscape of patent assets that are associated with the same or similar technologies as the patent portfolio 314. In various implementations, the intangible assets evaluation service 102 may determine a dataset including a number of patent assets of a number of organizations that have at least a threshold semantic similarity with respect to the patent portfolio 314. The number of patent assets included in the patent portfolio 314 may then be compared against the overall number of patent assets included in the dataset. The intangible assets evaluation service 102 may also determine organizations having at least a threshold number of patent assets included in the dataset and compare the number of patent assets of the patent portfolio 314 against the number of patent assets for organizations having at least the threshold number of patent assets in the dataset to determine a metric for the coverage footprint component. In particular implementations, the average amount of patent term remaining on the patent portfolio 314 may be compared against the average patent term remaining on the additional patent assets in the dataset to determine a metric for the coverage footprint component of the opportunity factors 326.

The opportunity factors 326 may also include a value creation component that relates to an amount of opportunities for an organization to develop technologies in technical areas that have less innovation than other technical areas. In various implementations, the intangible assets evaluation service 102 may determine a number of patent assets included in technical areas that are related to the patent portfolio 314. The intangible assets evaluation service 102 may determine a metric for the value creation component based on a number of overall patent assets within technical areas associated with the patent portfolio 314. The intangible assets evaluation service 102 may determine a relatively higher metric for the patent portfolio 314 with respect to value creation in situations where the overall number of patent assets in a particular technical area is less than a threshold number.

The opportunity factors 326 may also include a secondary uses component that relates to other technical areas that may be covered by the patent portfolio 314. In various implementations, a primary use of the patent portfolio 314 may include applying at least a portion of the patent portfolio 314 in a technical area directly related to the business of the organization associated with the patent portfolio 314. The intangible assets evaluation service 102 may determine a metric for the other uses component by identifying additional technical areas that may be covered by the patent portfolio 314. For example, analysis of the landscape of the semantically similar assets may indicate that the patented technology has a number of applications, including the primary use applicable to the owner of patent portfolio 314 and secondary uses not currently pursued by the owner. Further, the intangible assets evaluation service 102 may determine that in situations where claims of patent assets of the patent portfolio 314 may be broadened, the patent portfolio 314 may cover products and/or services related to different technical areas than the current claims of one or more patent assets of the patent portfolio 314. Additionally, the intangible assets evaluation service 102 may determine that the one or more patent assets of the patent portfolio 314 may include additional subject matter that is unclaimed and may be used to generate claims that cover technical areas that are different from the technical areas covered by the current claims of one or more patent assets of the patent portfolio 314.

Further, the opportunity factors 326 may include a licensing potential component that corresponds to existing and/or potential licensing of the patent portfolio 314. In various implementations, potential licensing opportunities may be determined by the intangible assets evaluation service 102 by identifying organizations that have patent assets in the same or similar technical areas as the patent portfolio 314. In certain implementations, the intangible assets evaluation service 102 may determine licensing potential of the patent portfolio 314 by identifying organizations that have fewer patent assets than the organization 320 in the same or similar technical area as the patent portfolio 314. The intangible assets evaluation service 102 may also determine licensing potential of the patent portfolio 314 by identifying organizations that have a threshold amount of revenue and/or profit and also have less than a threshold number of patent assets in a technical area associated with the patent portfolio 314.

The opportunity factors 326 may also include an infringing goods component that corresponds to identifying goods and/or services offered by additional organizations that are covered by claims of one or more patent assets of the patent portfolio 314. The existence of goods and/or services that infringe at least one claim of a patent asset of the patent portfolio 314 may increase the opportunity related to the patent portfolio 314 due to the possibility of enforcement of the at least one claim against additional organizations. In various implementations, the intangible assets evaluation service 102 may determine a metric for the infringing goods component by identifying goods and/or services of additional organizations that are the subject of litigation. In some examples, the litigation may be related to one or more patent assets included in the patent portfolio 314, while in other examples, the litigation may be related to patent assets in the same or similar technical area as the patent portfolio 314. In still other examples, the litigation may be related to patent assets of additional organizations that have patent assets that have at least a threshold semantic similarity with respect to one or more patent assets included in the patent portfolio 314. In certain implementations, the intangible assets evaluation service 102 may identify potentially infringing goods and/or services by comparing marketing materials, websites, and/or product specifications of goods and/or services in the same or similar technical areas as one or more patent assets included in the patent portfolio 314 to elements of the claims of one or more patent assets of the patent portfolio 314.

After evaluating the opportunity factors 326 with respect to the patent portfolio 314, the intangible assets evaluation service 102 may determine one or more opportunity metrics 328 for the patent portfolio 314. The one or more opportunity metrics 328 for the patent portfolio 314 may be included in a scale related to opportunity. In an illustrative example, the intangible assets evaluation service 102 may determine an opportunity metric 328 for the patent portfolio 314 on a scale from limited to expansive.

At 330, the intangible assets evaluation service 102 may determine risk related to the patent portfolio 314. The risk may be determined in relation to one or more risk factors 332. The one or more risk factors 332 may include a validity component. The intangible assets evaluation service 102 may determine a metric for a validity component of the patent portfolio 314 by analyzing the features of the claims of one or more patent assets of the patent portfolio 314 with respect to the specification of patents that have both a threshold semantic similarity to the patent assets and a publication date that would qualify the patents as prior art to the one or more patent assets. The risk metric may reflect the number of patents satisfying the semantic similarity and publication date thresholds or reflect the semantic similarity of the most semantically similar patent. The validity metric may also analyze the features of the claims of one or more patent assets of the patent portfolio 314 with respect to claims that are included in case law decisions where claims were invalidated. In certain situations, the intangible assets evaluation service 102 may perform a semantic analysis to determine a similarity between claims of one or more patent assets of the patent portfolio 314 and claims that have been invalidated in court decisions.

The risk factors 332 may also include a component associated with an impact of case law on claims of one or more patent assets of the patent portfolio 314. The intangible assets evaluation service 102 may determine a metric for the case law impact component by identifying decisions made by courts with respect to particular areas of patent law, such as enablement, subject matter eligibility, anticipation, and obviousness. The intangible assets evaluation service 102 may then perform a semantic analysis of claims of one or more patent assets of the patent portfolio 314 with respect to claims of the decisions in each area of patent law to determine an amount of similarity between the claims of the decisions and the claims of the one or more patent assets of the patent portfolio 314. In certain implementations, events that occur during prosecution history of one or more patent assets of the patent portfolio 314 may be compared with events that occurred with respect to the patents that were the subject of the decisions to determine a metric for the case law impact component.

In addition, the risk factors 332 may include a design around component that indicates an amount of changes that can be made to an infringing product in order to avoid claims of one or more patent assets of the patent portfolio 314. In various implementations, the intangible assets evaluation service 102 may determine an amount of overlap between one or more features of products and/or services offered by additional organizations and the claims of one or more patent assets of the patent portfolio 314. Based on the amount of overlap, the intangible assets evaluation service 102 may determine a cost to design around the claims of the one or more patent assets of the patent portfolio 314, an amount of time to produce a product and/or service that does not infringe the claims of the one or more patent assets of the patent portfolio 314, and an efficiency of the new design. The intangible assets evaluation service 102 may determine a metric for the design around component based on the various costs and amount of time to design a new product and/or implement a new service that does not infringe the claims of one or more patent assets of the patent portfolio 314.

Further, the risk factors 332 may include a non-infringing substitutes component that corresponds to a product and/or service that can be substituted for a product and/or service that infringes at least one claim of one or more patent assets of the patent portfolio 314. In various implementations, the intangible assets evaluation service 102 may identify one or more products and/or services that are similar to a product and/or service that infringes at least one claim of one or more patent assets of the patent portfolio 314 and compare features of the one or more products and/or services that are similar to the infringing product with elements of claims of the one or more patent assets of the patent portfolio 314. Based on the comparison, the intangible assets evaluation service 102 may identify a product and/or service that does not infringe claims of one or more patent assets of the patent portfolio 314. The intangible assets evaluation service 102 may then determine a cost of the non-infringing product and/or service, a time to produce or implement the non-infringing product and/or service, and an efficiency of the non-infringing product and/or service. The intangible assets evaluation service 102 may determine a metric of the non-infringing substitutes component based on the cost, time to produce, and efficiency of the non-infringing product and/or service.

In addition, the risk factors 332 may include an expiration component that corresponds to an amount of patent term remaining on patent assets of the patent portfolio 314. The intangible assets evaluation service 102 may determine a metric for the expiration component based on the respective amounts of time remaining on the patent term of one or more patent assets of the patent portfolio 314. In particular implementations, the intangible assets evaluation service 102 may determine a metric for the expiration component based on an average patent term remaining for patent assets of the patent portfolio 314.

The risk factors 332 may also include a jurisdictional component that relates to jurisdictions where products and/or services associated with the patent portfolio 314 are offered and patent coverage in those jurisdictions. The intangible assets evaluation service 102 may determine jurisdictions associated with one or more patent assets of the patent portfolio 314 and compare those jurisdictions with jurisdictions where products and/or services related to the patent portfolio 314 are offered. The intangible assets evaluation service 102 may determine a metric for the jurisdictional component based on the jurisdictions of one or more patent assets of the patent portfolio 314 corresponding to the jurisdictions where the products and/or services associated with the one or more patent assets of the patent portfolio 314 are offered.

After evaluating the patent portfolio 314 with respect to the risk factors 332, the intangible assets evaluation service 102 may determine one or more risk metrics 334. In certain implementations, the one or more risk metrics may be presented with respect to a scale. In illustrative implementations, a scale associated with the risk metrics 334 may range from a low risk to a high risk for the patent portfolio 314.

The one or more coverage metrics 322, the one or more opportunity metrics 328, and the one or more risk metrics 334 may be combined to produce an overall qualitative metric. In various implementations, weightings may be applied to the one or more coverage metrics 322, the one or more opportunity metrics 328, and the one or more risk metrics 334 to generate the overall qualitative metric. In certain implementations, at least one of the one or more coverage metrics 322, the one or more opportunity metrics 328, or the one or more risk metrics 334 may be stored by, or in association with, the intangible assets evaluation service 102 for use in subsequent qualitative analyses and/or quantitative analyses of patent portfolios. The use of at least one of the one or more coverage metrics 322, the one or more opportunity metrics 328, or the risk metrics 334 may improve the accuracy of subsequent qualitative analyses and/or quantitative analyses of additional patent portfolios.

The intangible assets evaluation service 102 may also perform a quantitative analysis 336 of one or more of the patent portfolio 314. In some situations, the intangible assets evaluation service 102 may perform the quantitative analysis 336 with respect to a single patent asset of the patent portfolio 314, while in other scenarios, the intangible assets evaluation service 102 may perform the quantitative analysis 336 with respect to a group of patent assets included in the patent portfolio 314. At 338, the quantitative analysis 336 performed by the intangible assets evaluation service 102 may include determining monetary valuation metrics 340 for one or more patent assets of the patent portfolio 314. In particular examples, the valuation metrics 340 may include monetary valuations of one or more the patent assets of the patent portfolio 314.

The quantitative analysis 336 performed by the intangible assets evaluation service 102 may utilize one or more valuation methodologies 342 and one or more valuation premises 344. The one or more valuation methodologies 342 may include a cost methodology. The cost methodology may correspond to a cost incurred to reproduce the patent portfolio 314. The costs incurred to reproduce the patent portfolio 314 may correspond to legal costs to obtain the patent portfolio 314 and at least a portion of the research and development costs incurred to produce the technologies associated with the patent portfolio 314.

The valuation methodologies 342 may also include a market methodology that relates to a market indication of value such as sales price, other commercialization price, or valuation analysis of the patent portfolio 314 or a portion of the patent portfolio 314. The market methodology may include comparing the patent portfolio 314 with patent assets in the same or similar technical area that have been commercialized. Commercialization of patent assets may include at least one of licensing transactions, sales of patent assets, or enforcement of patent assets in litigation proceedings or administrative proceedings. Valuation analyses may include at least results of previous valuations performed by intangible assets evaluation service 102, stored in additional data source 306, enabling rich comparison on the basis of both qualitative analysis with both the qualitative analysis 316 and quantitative analysis 336. In particular implementations, the market methodology may also include evaluating a market value of the patent portfolio 314 or a portion of the patent portfolio 314 based on the qualitative metrics determined by the qualitative analysis 316 performed by the intangible assets evaluation service 102. In situations where the qualitative metrics are favorable with respect to the patent portfolio 314, the intangible assets evaluation service 102 may determine relatively higher monetary valuation metrics 340 for the patent portfolio 314 than for, for example, the average patent sales transaction in the same or similar technical area. In scenarios where the qualitative metrics are less favorable with respect to the patent portfolio 314, the intangible assets evaluation service 102 may determine that a discount is to be applied to the monetary valuation metrics 340 of the patent portfolio 314 relative to, for example, the average patent sales transaction in the same or similar technical area.

The valuation methodologies 342 may also include an income methodology that corresponds to the present value of income and profit streams that may be generated by the patent portfolio 314 or a portion of the patent portfolio 314 that are realized through commercialization of at least a portion of the patent portfolio 314. The income streams may include licensing revenue and the sale of goods and/or services that are associated with the patent portfolio 314. In particular implementations, the intangible assets evaluation service 102 may implement the income methodology by determining potential profits for individual patent assets of the patent portfolio 314. The intangible assets evaluation service 102 may also implement the income methodology by determining potential profits for a group of patent assets included in the patent portfolio 314. The intangible assets evaluation service 102 may determine the profit potential for a single patent or group of patent assets based at least in part upon inputs from the qualitative analysis 316 such as determination of the semantic relationship of the patent or group of patent assets to the products or services associated with the profits. In various implementations, the information utilized by the intangible assets evaluation service 102 to determine the potential revenue streams realized by commercialization of the patent portfolio 314 may be associated with patent assets of other organizations that are in a same or similar technical area as the patent assets of the patent portfolio 314 and that have been commercialized. In additional implementations, the information utilized by the intangible assets evaluation service 102 to determine the potential profit streams realized by the commercialization of the patent portfolio 314 may be associated with patent assets of other organizations that have been commercialized and have at least a threshold amount of semantic similarity with respect to the patent assets of the patent portfolio 314. Generating valuation metrics 340 according to the income method may also take into account revenue from existing licensing endeavors and/or terms of potential licenses with respect to the patent portfolio 314.

The one or more valuation premises 344 may include a liquidation premise and one or more fair value premises. The liquidation premise corresponds to an amount of revenue generated by sale of at least a portion of the patent assets of the patent portfolio 314 in the event that the organization 320 ceases to do business. The liquidation premise may be utilized in conjunction with one or more methodologies such as the cost methodology and/or the market methodology to generate the one or more valuation metrics 340. The fair value premises correspond to scenarios where the organization 320 remains in business and generates revenue from at least a portion of the patent portfolio 314. The fair value premises may be utilized in conjunction with one or more methodologies such as the income methodology to generate the one or more valuation metrics 340.

In various implementations, the one or more valuation metrics 340 may include a current liquidation value of the patent portfolio 314 and/or a going concern value of the patent portfolio 314. Additionally, the one or more valuation metrics 340 may include multiple monetary values related to the patent portfolio 314 shown over a period of time. For example, the one or more valuation metrics 340 may include a graph plotting projections of monetary values of the patent portfolio 314 over a period of time, such as 6 months, one year, two years, three years, etc. Further, the one or more valuation metrics 340 may include a graph plotting projections of monetary values of the patent portfolio 314 over a lifetime of at least a portion of the patent portfolio 314.

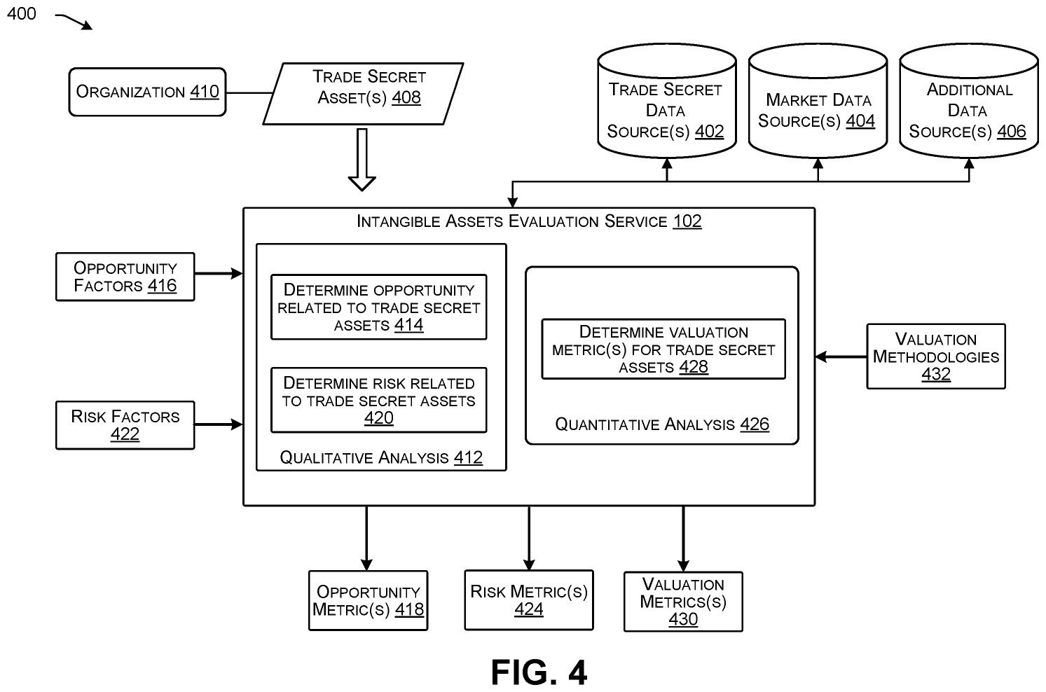

FIG. 4 illustrates an example system 400 to perform a qualitative analysis and a quantitative analysis of trade secret data according to some implementations. Although the illustrative implementations of FIG. 4 are directed to the analysis of trade secret data, in additional implementations, the system 400 may be adapted for other types of intangible assets. The system 400 includes the intangible assets evaluation service 102. The intangible assets evaluation service 102 may be coupled to or otherwise in electronic communication with one or more trade secret data sources 402, one or more market data sources 404, and one or more additional data sources 406. The intangible assets evaluation service 102 may retrieve data from the data sources 402, 404, 406 to perform qualitative analyses and quantitative analyses of trade secret assets to determine qualitative metrics and quantitative metrics with respect to trade secret assets. The one or more trade secret data sources 402 may store information about trade secrets from one or more organizations including trade secrets assets 408 of the organization 410. The trade secret data sources 402 may store data including proprietary methods, systems, algorithms, software code, designs, formulations, and other documentation corresponding to trade secrets of organizations. The one or more trade secret data sources 402 may also include data related to trade secret litigation proceedings. The one or more market data sources 404 may store data related to products and/or services offered by organizations and markets where the products and/or services are offered. The one or more additional data sources 406 may store additional data utilized by the intangible assets evaluation service 102 to perform qualitative and quantitative analyses of trade secret assets. For example, the one or more additional data sources 406 may store financial data associated with organizations that hold trade secret assets, marketing and business information of organizations that hold trade secret assets, and employee and/or inventor information for organizations that hold trade secret assets. In some implementations, the one or more additional data sources 406 may include data stores of one or more organizations that are accessible to the intangible assets evaluation service 102. Further, in particular implementations, at least a portion of the data stored by the one or more additional data sources 406 may be obtained by the intangible assets evaluation service 102 from one or more organizations that hold trade secret assets.

In the illustrative example of FIG. 4, the intangible assets evaluation service 102 may analyze a number of trade secret assets 408 of the organization 410. In certain implementations, the intangible assets evaluation service 102 may analyze at least a portion of the trade secret assets 408. In particular implementations, the intangible assets evaluation service 102 may perform a qualitative analysis 412 with respect to the trade secret assets 408 of the organization 410 that includes, at 420, determining opportunity related to one or more of the trade secret assets 408. Determining the opportunity of the trade secret assets 408 may include evaluating one or more opportunity factors 416 with respect to at least a portion of the trade secret assets 408. The intangible assets evaluation service 102 may perform the qualitative analysis 412 by obtaining data from the data sources 402, 404, 406. The data obtained from the data sources 402, 404, 406 may include a business plan of an organization 410, a marketing strategy of the organization 410, and information related to product and/or service offerings by the organization 410. The intangible assets evaluation service 102 may also obtain additional data from the data sources 402, 404, 406, such as research and development costs related to developing the trade secret assets 408. Further, the intangible assets evaluation service 102 may obtain data related to present markets where goods and/or services of the organization 410 are offered, future markets where the goods and/or services of the organization 410 may be offered, known competitors of the organization 410, potential competitors of the organization 410, financial data of the organization 410, financial forecasts of the organization 410, information related to employees of the organization 410 (e.g., employee agreements, intellectual property assignments, etc.), and information regarding any ongoing or past legal disputes related to intellectual property of the organization 410.

The intangible assets evaluation service 102 may determine one or more opportunity metrics 418 based on evaluating the opportunity factors 416 with respect to trade secret data of the organization 410. The opportunity factors 416 may include a relevant industry component that corresponds to one or more classifications of an industry related to the trade secrets 408. In certain implementations, the classification of the industry related to the trade secrets 408 may be based on the Global Industry Classification Standard (GICS). The intangible assets evaluation service 102 may determine the relevant industry for the trade secret assets 408 by comparing information related to the trade secrets 408 with products and/or services included in the various classifications of the GICS.

The opportunity factors 416 may also include an information type corresponding to the trade secret assets 408. In particular implementations, the information type may include industrial secrets that are related to information used directly in the manufacture of products or delivery of services. Industrial secrets may include product designs, computer code, and chemical formulations. Another information type may include commercial secrets that are used indirectly, such as in an operational role or administrative role in support of revenue of the organization 410. Commercial secrets may include customer lists and product pricing information. In various implementations, the intangible assets evaluation service 102 may determine one or more opportunity metrics 418 for the trade secret assets 408 based on determining that the trade secret assets 408 are industrial secrets or commercial secrets. In particular implementations, opportunity metrics 418 may be relatively higher for industrial secrets because industrial secrets are more likely to be used directly in the profit generation of competing products or services where commercial secrets are more likely to be utilized in business operations of the organization 410. Additionally, the likelihood of industrial secrets being tied to revenue of the organization 410 is higher than for commercial secrets. Further, detectability of use with respect to industrial secrets corresponding to one or more products and/or services of the organization 410 is higher than for commercial secrets.

Additionally, the opportunity factors 416 may include scope of the trade secret assets 408. The intangible assets evaluation service 102 may determine a scope of the trade secret assets 408 based on determining a correlation between revenue of the organization 410 and the trade secret assets 408. Further, the opportunity factors 416 may include useful commercial life of the trade secrets 408 that corresponds to an amount of time that the trade secrets 408 may be utilized by the organization 410 to produce revenue. The intangible assets evaluation service 102 may determine an opportunity metric 418 associated with the component of useful commercial life based on trends in competing technologies and trends in a market in which the products and/or services associated with the trade secret assets 408 is included.

In particular implementations, the opportunity factors 402 may also include distinctiveness that corresponds to available substitutes or alternatives to the products and/or services that correspond to the trade secret assets 408. The intangible assets evaluation service 102 may determine an opportunity metric 418 for the component of distinctiveness based on a number of alternative products and/or services associated with the trade secret assets 408, the commercial viability of the alternative products and/or services, and the efficiency of functionality of the alternative products and/or services. The opportunity factors 416 may also include geographic reach of the trade secret assets 408 that corresponds to the jurisdictions in which the trade secret assets 408 may be enforced. The intangible assets evaluation service 102 may determine an opportunity metric 418 for the component of geographic reach based on enforcement of the trade secret assets 408 at a local level, a national level, a regional level, or an international level.

At 420, the intangible assets evaluation service 102 may determine risk related to the trade secret assets 408 based on one or more risk factors 422. The risk associated with the trade secret assets 408 may correspond to limitations on the realization of the opportunity afforded by the trade secret assets 408. The risk factors 422 may include level of secrecy that corresponds to measures taken by the organization 410 to uphold the secrecy of the trade secrets 408. The intangible assets evaluation service 102 may determine a risk metric 424 for level of secrecy by determining the extent to which information associated with the trade secrets 408 has been disseminated, including on a confidential basis. The intangible assets evaluation service 102 may determine the risk metric 424 for level of secrecy by analyzing communications that are internal and external to the organization 410 with respect to the trade secret assets 408. In various implementations, the risk metric 424 may be determined by the intangible assets evaluation service 102 based on a number of members of the organization 410 that know about the entirety of the trade secret assets 408, a number of members of the organization 410 that know about portions of the trade secret assets 408, the role of the members of the organization 410 with knowledge of the trade secret assets 408, policies and procedures for ensuring the secrecy of the trade secret assets 408, technical security measures in place to protect digital information regarding trade secret assets 408, and oversight and review of the implementation of the policies and procedures for ensuring the secrecy of the trade secret assets 408.

In addition, the risk factors 422 may include a reproducibility component for the trade secret assets 408 based on knowledge of the products and/or services of the organization 410 that are related to the trade secret assets 408. The intangible assets evaluation service 102 may determine a risk metric 424 for the reproducibility component based on public awareness of the existence of the trade secret assets 408, such as availability of the products and/or services related to the trade secret assets 408 in the marketplace and promotion of the novel or unique functionality of the products and/or novel aspects of services related to the trade secret assets 408. The intangible assets evaluation service 102 may also determine a risk metric 424 for the reproducibility component based on public access to the same or similar information utilized by the organization 410 in developing the trade secret assets 408, the ability of other organizations to reproduce the trade secret assets 408 based on the information available to them, and the amount of time and effort for additional organizations to reproduce the trade secret assets 408.

Further, the risk factors 422 may include a misappropriation component that relates to a possibility that unauthorized access to information associated with the trade secret assets 408 may be obtained. The intangible assets evaluation service 102 may determine a risk metric 424 for the misappropriation component based on an extent to which information associated with the trade secret assets 408 is shared externally with third parties and the extent to which the third parties may have the resources, such as human resources and/or industrial resources, to reproduce the trade secret assets 408.

The risk factors 422 may also include detectability of use component for the trade secret assets 408 by other organizations that corresponds to certain features of the trade secret assets 408. In particular implementations, the intangible assets evaluation service 102 may determine a risk metric 424 for the detectability of use component based on identifying characteristics of the trade secret assets 408 that may become known to the organization 410 in situations where other organizations are utilizing the trade secret assets 408 and access to business activities of organizations that may be implementing the trade secret assets 408. In particular implementations, the risk metric 424 for the detectability of use component may be determined based on communications between the organization 410 and third parties that may implement features of the trade secret assets 408 and/or publicly available information, such as press releases, marketing materials, patent documents, websites, and the like, about activities of third parties that may be implementing features of the trade secret assets 408.

In various implementations, the risk factors 422 may include an overlapping coverage component that corresponds to the extent that the trade secret assets 408 are protected solely under trade secret laws and doctrines. Overlapping coverage for the trade secret assets 408 may reduce the risk of loss of intellectual property rights to the extent that one or more features of the trade secret assets are covered by other forms of intellectual property. The intangible assets evaluation service 102 may determine a risk metric 424 for the overlapping coverage component by analyzing other intellectual property assets of the organization with respect to features of the trade secret assets 408.

Although the qualitative analysis 412 is described in the illustrative implementations of FIG. 4 with some differences with respect to the qualitative analysis 316 of FIG. 3, the qualitative analysis 412 may also the same or have additional similarities with respect to the qualitative analysis 316. For example, the determination of opportunity of the trade secret assets 408 at 414 may parallel the determination of opportunity described with respect to 324 in FIG. 3. Additionally, the determination of risk of the trade secret assets 408 may parallel the determination of risk described with respect to 330 in FIG. 3. Furthermore, one or more of the coverage factors 320 of FIG. 3 may be evaluated with respect to the determination of opportunity at 414 and/or the determination of risk at 420 in FIG. 4. In this way, a common framework may be implemented to perform quantitative analyses of both patent assets and trade secret assets.

The intangible assets evaluation service 102 may also perform a quantitative analysis 426 with respect to the trade secret assets 408. In particular, the intangible assets evaluation service 102 may, at 428, determine one or more valuation metrics 430 with respect to the trade secret assets 408. The intangible assets evaluation service 102 may utilize one or more valuation methodologies 432 to determine the valuation metrics 430. In particular implementations, the valuation metrics 430 may include monetary valuations of the trade secret assets 408. In various implementations, the valuation methodologies 432 may include an income model that determines a present value of the projected profits of the organization with and without the trade secret assets 408. In particular implementations, the intangible assets evaluation service 102 may determine an amount of profit of the organization 410 with the trade secret assets 408 by determining an amount of profit of the organization 410 that is attributable to sales of one or more products and/or services and correspond to the trade secret assets. 408. The intangible asset evaluation service 102 may determine an amount of profit of the organization without the trade secret assets 408 by determining profits prior to commercialization of the trade secret assets 408.

The valuation models 432 may also include a replacement cost model that corresponds to a differential of profits for a third party with and without implementing the trade secret assets 408. In particular implementations, the intangible assets evaluation service 102 may determine revenue of a third party without implementing the features of the trade secret assets 408 by estimating profits of the third party based on a substitution of one or more products and/or services associated with the trade secret assets 408 for one or more additional products and/or services that are available in the marketplace.

Additionally, the valuation methodologies 432 may include a development cost model that corresponds to a cost incurred by a third party to reproduce the trade secret assets 408. The intangible assets evaluation service 102 may determine a cost for a third party to reproduce the trade secret assets 408 by determining a number of personnel that worked on the development of the trade secret assets 408, wages for the personnel, and a number of hours that the personnel worked in order to develop the trade secret assets 408.

In some implementations, the intangible assets evaluation service 102 may generate a single valuation metric 430 that incorporates the individual valuation metrics 430 corresponding to a plurality of the valuation methodologies 432. For example, the intangible assets evaluation service 102 may determine an average valuation metric 430 for the trade secret assets 408 based on individual valuation metrics 430 determined according to the income valuation model, the replacement cost valuation model, and the development cost valuation model. The intangible assets evaluation service 102 may determine a range of valuation metrics produced by implementing the individual valuation models 432.

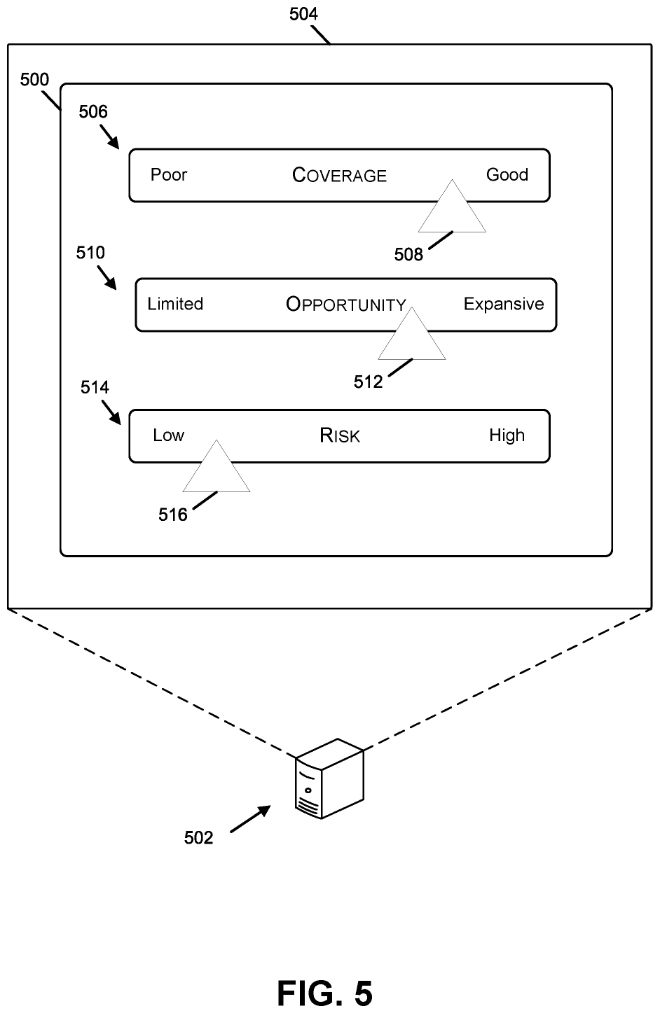

FIG. 5 illustrates an example user interface 500 displaying results of a qualitative analysis of intellectual property data according to some implementations. The user interface 500 may be generated by a computing device 502 and presented via a display device 504 of the computing device 502. The user interface 500 includes a first scale 506 corresponding to a first qualitative factor. The first qualitative factor includes coverage of intellectual property assets and a first indicator 508 of the coverage of the intellectual property assets is shown with respect to the first scale 506. The user interface 500 also includes a second scale 510 corresponding to a second qualitative factor. The second qualitative factor includes opportunity of intellectual property assets and a second indicator 512 of the opportunity of the intellectual property assets is shown with respect to the second scale 510. Additionally, the user interface 500 includes a third scale 514 corresponding to a third qualitative factor. The third qualitative factor includes risk of intellectual property assets and a third indicator 516 of the risk of the intellectual property assets is shown with respect to the third scale 514. Although the scale for coverage, opportunity and risk are shown as different in FIG. 5, in some implementations all three metrics can be shown on the same scale ranging from Low to High.

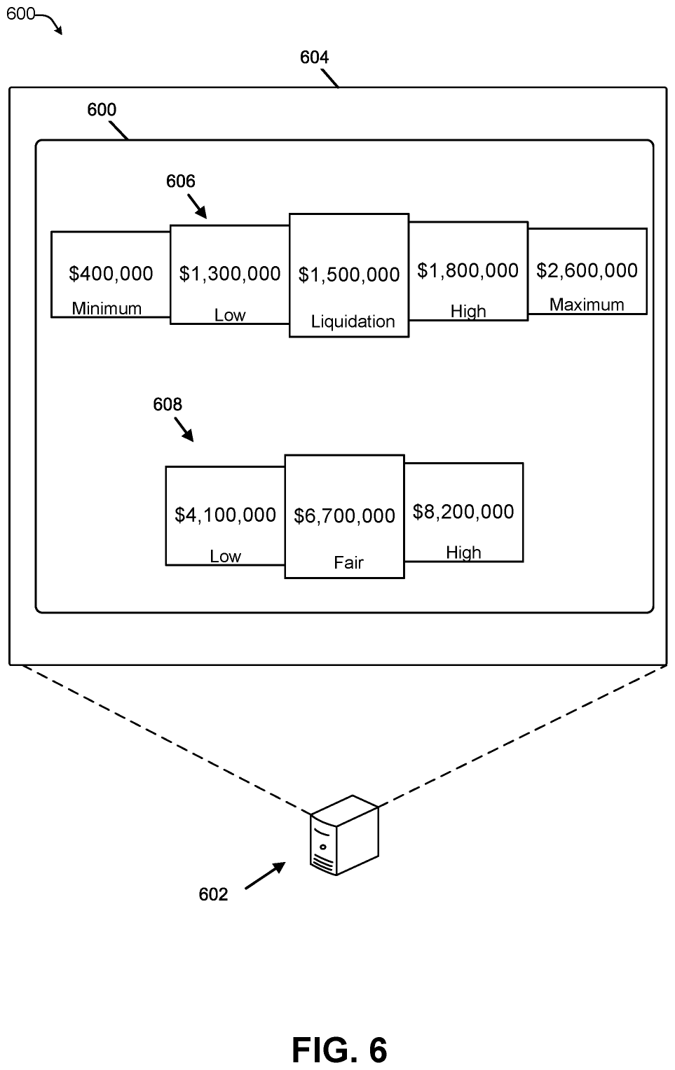

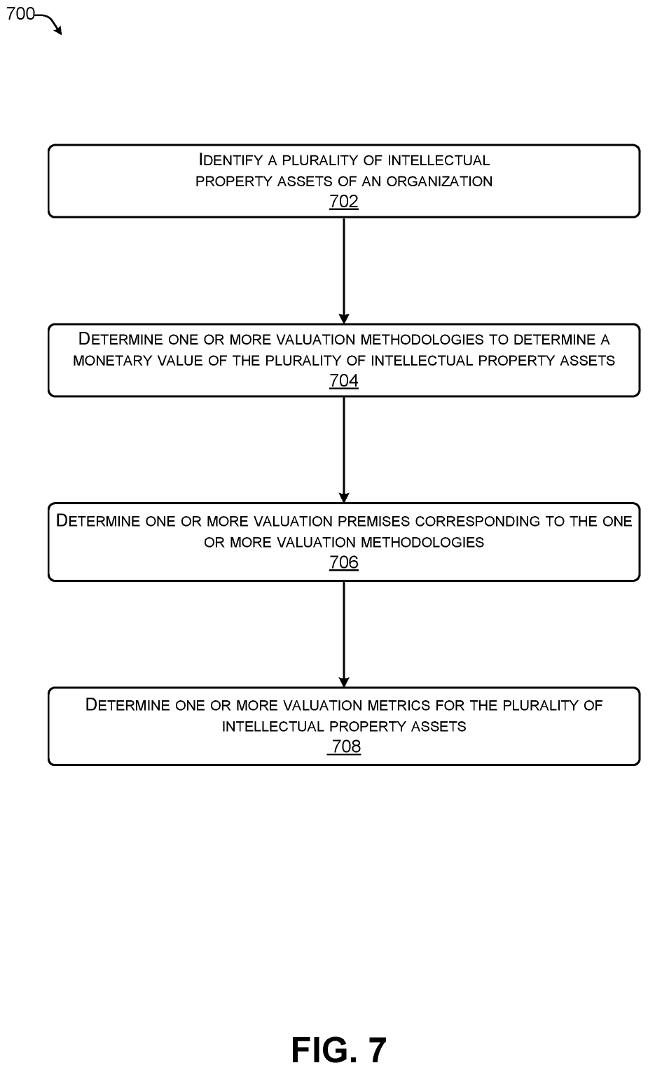

FIG. 6 illustrates an example user interface 600 displaying results of a quantitative analysis of intellectual property data according to some implementations. The user interface 600 may be generated by a computing device 602 and presented via a display device 604 of the computing device 602. The user interface 600 includes a first group of valuations 606 corresponding to a quantitative analysis performed according to a first methodology that includes a liquidation methodology. The user interface 600 also includes a second group of valuations 608 corresponding to a quantitative analysis performed according to a second methodology that includes a fair value methodology. The valuations displayed in FIG. 6 represent the value of the analyzed assets as of the current time. In some implementations, these valuations can be plotted over a time period of interest, such as a set time or the remaining expected life of the assets.

FIGS. 7-9 illustrate example processes of analyzing intangible assets, such as intellectual property, according to frameworks. These processes (as well as each process described herein) are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

FIG. 7 illustrates an example process 700 to analyze intellectual property data according to some implementations. At 702, the process 700 includes identifying a plurality of intellectual property assets of an organization. In particular implementations, the plurality of intellectual property assets of the organization may be identified via information provided by the organization indicating the plurality of intellectual property assets. Additionally, the plurality of intellectual property assets may be identified by parsing one or more intellectual property databases.

At 704, the process 700 includes determining one or more valuation methodologies to determine monetary value of the plurality of intellectual property assets. The one or more valuation methodologies may include an income methodology, a cost methodology, and a market methodology. A cost methodology may correspond to determining a first valuation metric for the plurality of intellectual property assets based at least partly on a cost to replace the plurality of intellectual property assets. A market methodology may correspond to determining a second valuation metric for the plurality of intellectual property assets based at least partly on a market sales price, other commercialization price, or valuation analysis of the plurality of intellectual property assets. In addition, an income methodology may correspond to determining a third valuation metric for the plurality of intellectual property assets based at least partly on profits obtained by the organization related to commercialization of the plurality of intellectual property assets.

At 706, the process 700 includes determining one or more valuation premises corresponding to the one or more valuation methodologies. A liquidation premise may correspond to a first predicted amount of revenue obtained by the organization with respect to a sale of at least a portion of the plurality of intellectual property assets in a scenario where the organization ceases operation. Further, a fair value premise may correspond to a second predicted amount of revenue obtained by the organization with respect to at least a portion of the plurality of intellectual property assets in a scenario where the organization continues operation.

At 708, the process 700 includes determining one or more valuation metrics for the plurality of intellectual property assets. The valuation metrics may be determined based at least partly on the one or more valuation methodologies and the one or more premises corresponding to the one or more valuation methodologies. In certain implementations, the valuation metrics may be determined based at least partly on financial data of the organization associated with the plurality of intellectual property assets. In addition, the valuation metrics may include monetary valuations of the plurality of intellectual property assets. Further, the valuation metrics may include previous analyses of comparable assets performed using the same process.

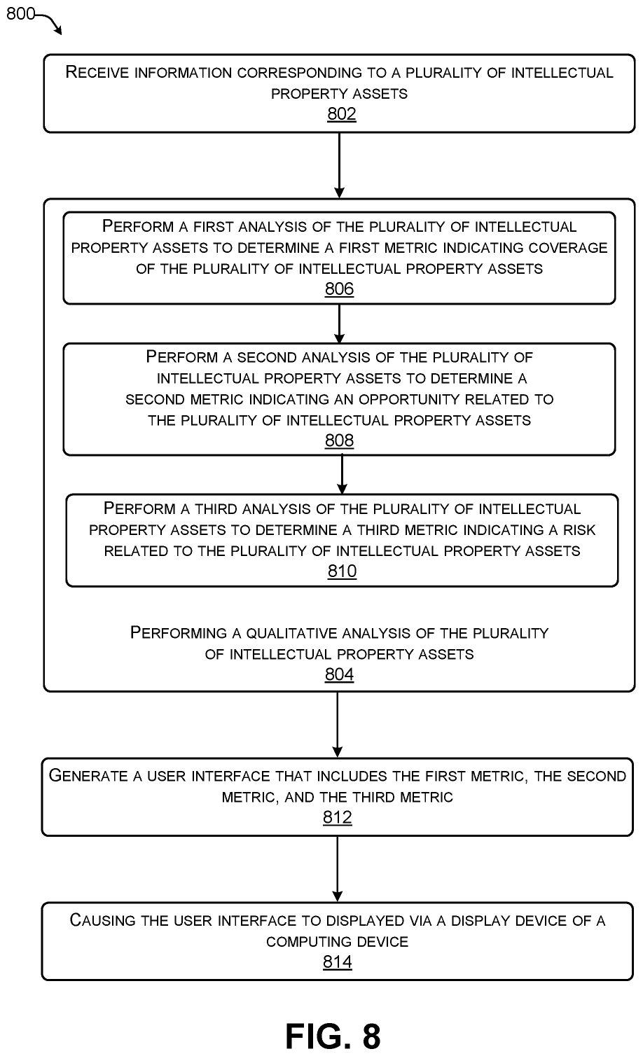

FIG. 8 illustrates an example process 800 to perform a qualitative analysis of intellectual property data according to some implementations. At 802, the process 800 includes receiving information corresponding to a plurality of intellectual property assets. The plurality of intellectual property assets may be associated with an organization.

At 804, the process 800 may include performing a qualitative analysis of the plurality of intellectual property assets. The qualitative analysis may be performed with respect to a framework that includes a number of factors and one or more components associated with the individual factors. The factors may include one or more of risk, coverage, and opportunity, with one particular implementation including all three and another particular implementation including risk and opportunity. The qualitative analysis may generate one or more metrics for each of the factors included in the framework. In particular implementations, a metric may be determined for individual components associated with each factor and the metrics of the individual components may be combined to generate an overall metric for a particular factor. For example, a metric may be determined for each component of an opportunity factor and the individual metrics for the components may be aggregated to produce an overall metric for the opportunity factor. In certain implementations, the metrics of the individual components may be weighted. In an illustrative example, the metrics of the individual components may be weighted at least substantially equally.

At 806, the process 800 includes performing a first analysis of the plurality of intellectual property assets to determine a first metric indicating coverage of the plurality of intellectual property assets. Coverage may correspond to a number of at least one of products or services of one or more organizations that are covered by the plurality of intellectual property assets. In addition, at 808, the process 800 includes performing a second analysis of the plurality of intellectual property assets to determine a second metric indicating an opportunity related to the plurality of intellectual property assets. Opportunity may correspond to a predicted amount of increase in revenue of the organization attributable to the plurality of intellectual property assets. Further, at 810, the process 800 includes performing a third analysis of the plurality of intellectual property assets to determine a third metric indicating a risk related to the plurality of intellectual property assets. Risk may correspond to a probability that at least one intellectual property asset of the plurality of intellectual property assets may be unable to contribute to the opportunity.

At 812, the process 800 includes generating a user interface that includes the first metric, the second metric, and a third metric. In various implementations, the first metric may be displayed in relation to a first scale relating to coverage, the second metric may be displayed in relation to a second scale relating to opportunity, and the third metric may be displayed in relation to a third scale relating to risk. In additional implementations, the scale for each of the first metric, the second metric, and the third metric may include a numerical scale with each of the first metric, the second metric, and the third metric being associated with a respective numerical score along the scale. In particular implementations, the numerical scale may be normalized with respect to the numerical scores of each of the factors. In illustrative examples, a numerical scale may be normalized from 1 to 100. In further implementations, the first metric, the second metric, and the third metric may be combined to produce an overall qualitative metric that may be presented along a scale. At 814, the process 800 includes causing the user interface to be displayed via a display device of a computing device. In particular implementations, an intangible assets evaluation service may make the user interface available to one or more user computing devices, such as via a browsing application or an intellectual property evaluation application.

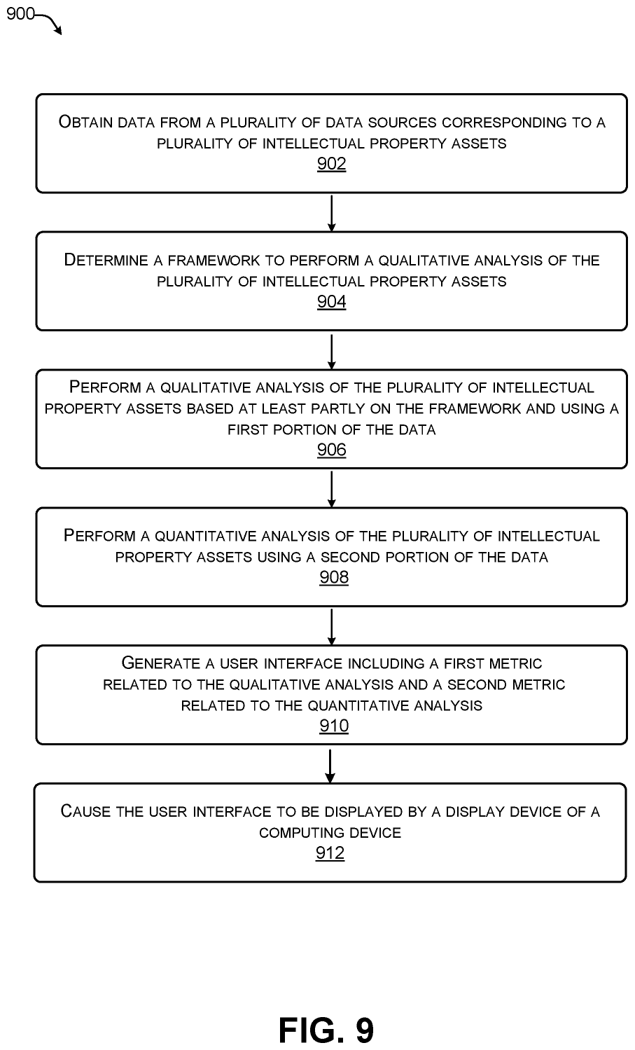

FIG. 9 illustrates an example process 900 to perform a quantitative analysis and a qualitative analysis of intellectual property data according to some implementations. At 902, the process 900 includes obtaining data from a plurality of data sources corresponding to a plurality of intellectual property assets of an organization. In certain implementations, the one or more data sources may be accessible via calls of one or more application programming interfaces (APIs).

At 904, the process 900 includes determining a framework to perform a qualitative analysis of the plurality of intellectual property assets. In various implementations, the framework may be determined based at least partly on a type of the intellectual property assets. For example, a first framework may be identified for patent assets, while a second framework is identified for trade secret assets. The framework may include one or more factors and one or more components corresponding to individual factors of the one or more factors. The factors and components may be the same for different intellectual property types or may be the same. The framework may indicate the sources and types of data appropriate for, and available to, the analysis, which may be different depending upon the type of intellectual property being analyzed. In illustrative implementations the one or more factors may include a risk factor that corresponds to a probability that at least one intellectual property asset of the plurality of intellectual property assets is unable to contribute to an increase in a potential amount of revenue that may be obtained by the organization based on the plurality of intellectual property assets. In certain implementations, a first component of the risk factor corresponds to litigation that includes at least one intellectual property asset of the plurality of intellectual property assets. In addition, a second component of the risk factor corresponds to a number of non-practicing entities that own intellectual property assets in a technical area associated with the plurality of intellectual property assets.

At 906, the process 900 includes performing a qualitative analysis of the plurality of intellectual property assets based at least partly on the framework and using a first portion of the data and, at 908, the process 900 includes performing a quantitative analysis of the plurality of intellectual property assets using a second portion of the data. In particular implementations, at least a portion of the data utilized to perform the qualitative analysis may be different from at least a portion of the data utilized to perform the quantitative analysis. That is, certain data associated with the plurality of intellectual property assets may be utilized to determine monetary valuations of the plurality of intellectual property assets, while other data may be utilized to evaluate the factors of the framework utilized in the qualitative analysis. The second portion of the data may include outputs of the qualitative analysis.

At 908, the process 900 includes generating a user interface including a first metric related to the qualitative analysis and a second metric related to the quantitative analysis. The first metric may correspond to a qualitative factor, such as coverage, risk, or opportunity. Additionally, the second metric may correspond to a monetary value of the plurality of intellectual property assets or a range of monetary values associated with the plurality of intellectual property assets. Further, at 910, the process 900 includes causing the user interface to be displayed via a display device of a computing device.

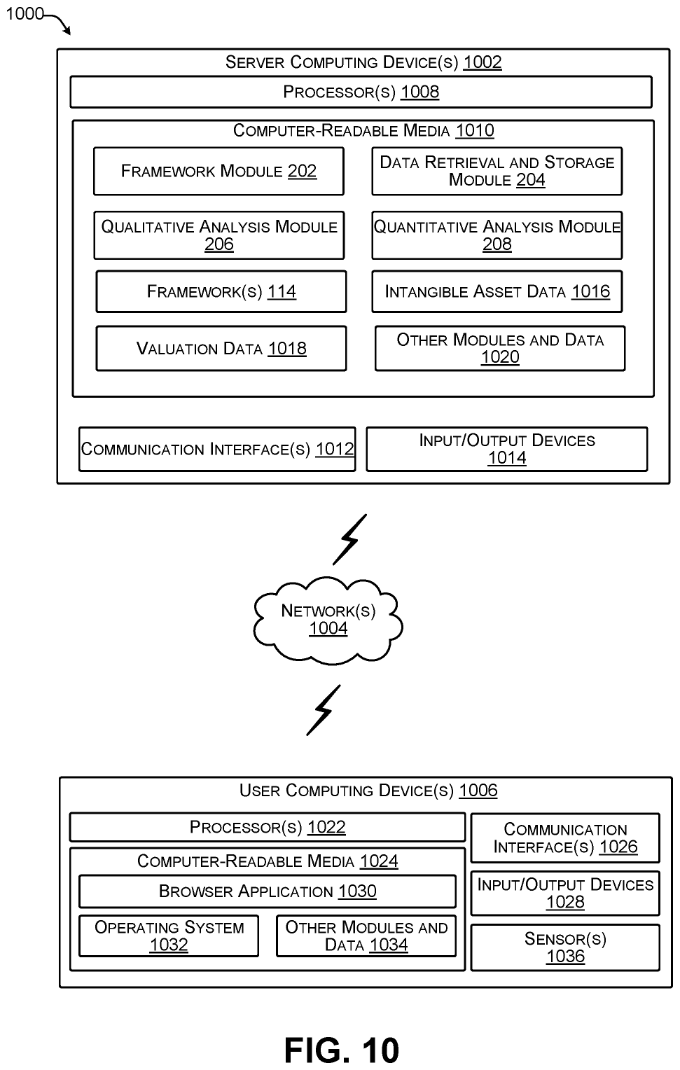

FIG. 10 illustrates an example system 1000 to utilize various frameworks to analyze intellectual property data according to some implementations. The system 1000 includes server computing device(s) 1002 (which can be associated with a service provider such as the intangible assets evaluation service 102) via network(s) 1004 (e.g., the Internet, cable network(s), cellular network(s), wireless network(s)(e.g., Wi-Fi) and wired network(s), as well as close-range communications such as Bluetooth®, Bluetooth® low energy, and the like). Additionally, in at least one example, one or more user computing device 1006 can communicate with the server computing device(s) 1002 via the network(s) 1004.

In at least one example, the user computing device(s) 1006 can be any suitable type of computing device, e.g., portable, semi-portable, semi-stationary, or stationary. Some examples of the user computing device(s) 1006 can include tablet computing devices; smart phones and mobile communication devices; laptops, netbooks and other portable computers or semi-portable computers; desktop computing devices, terminal computing devices and other semi-stationary or stationary computing devices; dedicated register devices; wearable computing devices, or other body-mounted computing devices; augmented reality devices; or other computing devices capable of sending communications and performing the functions according to the techniques described herein.

The server computing device(s) 1002 can include one or more servers or other types of computing devices that can be embodied in any number of ways. For example, in the example of a server, the modules, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server computing device(s) 1002 as being present in a single location, these components and data can alternatively be distributed across different computing devices and different locations in any manner. Consequently, the functions can be implemented by one or more server computing devices, with the various functionality described above distributed in various ways across the different computing devices. Multiple server computing device(s) 1002 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server computing device(s) 1002 can include one or more processors 1008, one or more computer-readable media 1010, one or more communication interfaces 1012, and one or more input/output devices 1014. Each processor 1008 can be a single processing unit or a number of processing units and can include single or multiple computing units or multiple processing cores. The processor(s) 1008 can be implemented as one or more microprocessors, microcomputers, microcontrollers, digital signal processors, central processing units, state machines, logic circuitries, and/or any devices that manipulate signals based on operational instructions. For example, the processor(s) 1008 can be one or more hardware processors and/or logic circuits of any suitable type specifically programmed or configured to execute the algorithms and processes described herein. The processor(s) 1008 can be configured to fetch and execute computer-readable instructions stored in the computer-readable media 1010, which can program the processor(s) 1008 to perform the functions described herein.

The computer-readable media 1010 can include volatile and nonvolatile memory and/or removable and non-removable media implemented in any type of technology for storage of information, such as computer-readable instructions, data structures, program modules, or other data. Such computer-readable media 1010 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server computing device(s) 1002, the computer-readable media 1010 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1010 can be used to store any number of functional components that are executable by the processors 1008. In many implementations, these functional components comprise instructions or programs that are executable by the processors 1008 and that, when executed, specifically configure the one or more processors 1008 to perform the actions attributed above to the service provider and/or service provider. Functional components stored in the computer-readable media 1010 can include the framework module 202, the data retrieval and storage module 204, the qualitative analysis module 206, the quantitative analysis module 204, and the frameworks 114, as described above with reference to FIG. 1 and FIG. 2.

Additionally, the computer-readable media 1010 can include intangible asset data 1016 that may be utilized by the qualitative analysis module 206 and the quantitative analysis module 208 to perform qualitative and quantitative analyses of intellectual property assets. The computer-readable media 1010 may also store valuation data 1018 that may include valuation methodologies, valuation models, and/or valuation premises that may be utilized to determine monetary valuations of intellectual property assets.

In at least one example, the computer-readable media 1010 can include or maintain other functional components and data, such as other modules and data 1020, which can include programs, drivers, one or more operating systems, etc., and the data used or generated by the functional components. Further, the server computing device(s) 1002 can include many other logical, programmatic and physical components, of which those described above are merely examples that are related to the discussion herein.

The communication interface(s) 1012 can include one or more interfaces and hardware components for enabling communication with various other devices, such as over the network(s) 1004. For example, communication interface(s) 1012 can enable communication through one or more of the Internet, cable networks, cellular networks, wireless networks (e.g., Wi-Fi) and wired networks, as well as close-range communications such as Bluetooth®, Bluetooth® low energy, and the like, as additionally enumerated elsewhere herein.

The server computing device(s) 1002 can further be equipped with various input/output (I/O) devices 1014. Such I/O devices 1014 can include a display, various user interface controls (e.g., buttons, joystick, keyboard, mouse, touch screen, etc.), audio speakers, connection ports and so forth.

In the illustrated example, the user computing device(s) 1006 include one or more processors 1022, one or more computer-readable media 1024, one or more communication interfaces 1026, and one or more input/output (I/O) devices 1028. Each processor 1022 can itself comprise one or more processors or processing cores. For example, the processor(s) 1022 can be implemented as one or more microprocessors, microcomputers, microcontrollers, digital signal processors, central processing units, state machines, logic circuitries, and/or any devices that manipulate signals based on operational instructions. In some examples, the processor(s) 1022 can be one or more hardware processors and/or logic circuits of any suitable type specifically programmed or configured to execute the algorithms and processes described herein. The processor(s) 1022 can be configured to fetch and execute computer-readable processor-executable instructions stored in the computer-readable media 1024.

Depending on the configuration of the user computing device(s) 1006, the computer-readable media 1024 can be an example of tangible non-transitory computer storage media and can include volatile and nonvolatile memory and/or removable and non-removable media implemented in any type of technology for storage of information such as computer-readable processor-executable instructions, data structures, program modules or other data. The computer-readable media 1024 can include, but is not limited to, RAM, ROM, EEPROM, flash memory, solid-state storage, magnetic disk storage, optical storage, and/or other computer-readable media technology. Further, in some examples, the user computing device(s) 708 can access external storage, such as RAID storage systems, storage arrays, network attached storage, storage area networks, cloud storage, or any other medium that can be used to store information and that can be accessed by the processor(s) 1022 directly or through another computing device or network. Accordingly, the computer-readable media 1024 can be computer storage media able to store instructions, modules or components that can be executed by the processor(s) 1022. Further, when mentioned, non-transitory computer-readable media exclude media such as energy, carrier signals, electromagnetic waves, and signals per se.

The computer-readable media 1024 can be used to store and maintain any number of functional components that are executable by the processor(s) 1022. In some implementations, these functional components comprise instructions or programs that are executable by the processor(s) 1022 and that, when executed, implement operational logic for performing the actions and services attributed above to the user computing device(s) 708. Functional components stored in the computer-readable media 1024 can include a browser application 1030 used to access user interfaces generated by the server computer(s) 1002.

Furthermore, the computer-readable media 1024 can include additional functional components, such as an operating system 1032 for controlling and managing various functions of the user computing device(s) 1006 and for enabling basic user interactions. In addition, the computer-readable media 1024 can also store data, data structures and the like, that are used by the functional components. Depending on the type of the user computing device(s) 1006, the computer-readable media 1024 can also optionally include other functional components and data, such as other modules and data 1034, which can include programs, drivers, etc., and the data used or generated by the functional components. Further, the user computing device(s) 708 can include many other logical, programmatic and physical components, of which those described are merely examples that are related to the discussion herein.

The communication interface(s) 1026 can include one or more interfaces and hardware components for enabling communication with various other devices, such as over the network(s) 1004 or directly. For example, communication interface(s) 1026 can enable communication through one or more of the Internet, cable networks, cellular networks, wireless networks (e.g., Wi-Fi) and wired networks, as well as close-range communications such as Bluetooth®, Bluetooth® low energy, and the like, as additionally enumerated elsewhere herein.

The user computing device(s) 1006 can further include the one or more I/O devices 1028. The I/O devices 1028 can include speakers, a microphone, a camera, a display (e.g., a liquid crystal display, a plasma display, a light emitting diode display, an OLED (organic light-emitting diode) display, an electronic paper display, or any other suitable type of display able to present digital content thereon), and various user controls (e.g., buttons, a joystick, a keyboard, a keypad, etc.), a haptic output device, and so forth.

Further, the user computing device(s) 1006 can include one or more sensors 1036, such as an accelerometer, gyroscope, compass, proximity sensor, camera, microphone, and/or a switch, a GPS sensor, etc.

Furthermore, the foregoing is merely illustrative of the principles of this disclosure and various modifications can be made by those skilled in the art without departing from the scope of this disclosure. The above described examples are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) can be made to further optimize the provided structures, devices and methods, as shown and described herein. In any event, the structures and devices, as well as the associated methods, described herein have many applications. Therefore, the disclosed subject matter should not be limited to any single example described herein, but rather should be construed in breadth and scope in accordance with the appended claims.

### Example Implementations

1. A method comprising: receiving, by an intangible assets evaluation service, information corresponding to a plurality of intellectual property assets; performing, by the intangible assets evaluation service and based at least partly on the information, a first analysis of the plurality of intellectual property assets to determine a first metric indicating coverage of the plurality of intellectual property assets, the plurality of intellectual property assets being associated with an organization and the coverage corresponding to a determined relationship between at least one of products or services of one or more organizations and the plurality of intellectual property assets; performing, by the intangible assets evaluation service, a second analysis of the plurality of intellectual property assets to determine a second metric indicating an opportunity related to the plurality of intellectual property assets, the opportunity corresponding to a potential increase in the revenue of the organization attributable to the plurality of intellectual property assets; performing, by the intangible assets evaluation service, a third analysis of the plurality of intellectual property assets to determine a third metric indicating a risk related to the plurality of intellectual property assets, the risk corresponding to a potential that at least one intellectual property asset of the plurality of intellectual property assets contributes to a decrease in the opportunity; generating, by the intangible assets evaluation service, a user interface that includes the first metric, the second metric, and the third metric; and causing, by the intangible assets evaluation service, the user interface to be displayed via a display device of a computing device.

2. The method of implementation 1, wherein: the method further comprises performing, by the intangible assets evaluation service, a quantitative analysis of the plurality of intellectual property assets to determine at least one monetary value of the plurality of intellectual property assets; and the quantitative analysis includes determining a monetary value of the plurality of intellectual property assets based on one or more valuation methodologies.

3. The method of implementation 1 or 2, wherein the method further comprises: determining, by the intangible assets evaluation service, a framework by which to evaluate the plurality of intellectual property assets; the framework includes a plurality of factors and one or more components associated with individual factors of the plurality of factors; and individual factors of the plurality of factors include the coverage, the opportunity, and the risk.

4. The method of implementation 3, wherein: the plurality of intellectual property assets includes a plurality of patents; and the framework includes: a first component related to the coverage, the first component including a strength of claims of one or more patents of the plurality of patents; a second component related to the opportunity, the second component including market size corresponding to one or more products, one or more services, or both that are associated with the claims of the one or more patents of the plurality of patents; and a third component related to the risk, the third component corresponding to a probability of the claims of the one or more patents of the plurality of patents being invalidated in a litigation proceeding or in an administrative proceeding.

5. The method of implementation 3, wherein: the framework indicates a plurality of types of data corresponding to individual factors of the plurality of factors; first types of data obtained from first data sources are used to determine the first metric; second types of data obtained from second data sources are used to determine the second metric; and third types of data obtained from third data sources are used to determine the third metric.

6. The method of implementation 3, wherein the framework includes a plurality of mitigating factors, the individual mitigating factors of the plurality of mitigating factors modifying at least one of the first metric, the second metric, or the third metric.

7. A system comprising: one or more processors; and one or more computer-readable media storing instructions executable by the one or more processors, wherein the instructions, when executed by the one or more processors, cause the one or more processors to perform acts comprising: identifying a plurality of intellectual property assets of an organization; determining one or more valuation methodologies to determine a monetary value of the plurality of intellectual property assets; determining one or more valuation premises corresponding to the one or more valuation methodologies; and determining one or more valuation metrics for the plurality of intellectual property assets based at least partly on applying the one or more valuation methodologies and the one or more valuation premises with respect to financial data of the organization associated with the plurality of intellectual property assets.

8. The system of implementation 7, further comprising: the one or more computer-readable media storing additional instructions executable by the one or more processors, wherein the additional instructions, when executed by the one or more processors, cause the one or more processors to perform additional acts comprising: obtaining data from a number of data sources corresponding to revenue generated by one or more goods, one or more services, or both that are covered by the plurality of intellectual property assets and corresponding to costs incurred by the organization to obtain the plurality of intellectual property assets.

9. The system of implementation 7 or 8, further comprising: the one or more computer-readable media storing additional instructions executable by the one or more processors, wherein the additional instructions, when executed by the one or more processors, cause the one or more processors to perform additional acts comprising: performing a first semantic analysis with respect to the plurality of intellectual property assets; identifying an additional plurality of intellectual property assets within a same technology area as the plurality of intellectual property assets, and performing a second semantic analysis with respect to the additional plurality of intellectual property assets; performing a second semantic analysis with respect to the additional plurality of intellectual property assets; and determining an amount of semantic similarity between the plurality of intellectual property assets and the additional plurality of intellectual property assets.

10. The system of implementation 9, further comprising: the one or more computer-readable media storing further instructions executable by the one or more processors, wherein the further instructions, when executed by the one or more processors, cause the one or more processors to perform further acts comprising: determining that the amount of semantic similarity is greater than a threshold; and performing at least a portion of a qualitative analysis of the plurality of intellectual property assets with respect to information corresponding to the additional plurality of intellectual property assets.

11. The system of any one of implementations 7-9, wherein the one or more valuation methodologies include: a cost methodology corresponding to determining a first valuation metric for the plurality of intellectual property assets based at least partly on a cost to replace the plurality of intellectual property assets; a market methodology corresponding to determining a second valuation metric for the plurality of intellectual property assets based at least partly on an indication of value of an additional plurality of intellectual property assets: and an income methodology corresponding to determining a third valuation metric for the plurality of intellectual property assets based at least partly on revenue obtained by the organization related to commercialization of the plurality of intellectual property assets.

12. The system of implementation 11, wherein the second valuation metric is determined based at least partly on at least one of one or more first additional valuation metrics corresponding to one or more additional intellectual property assets of the organization or one or more second additional valuation metrics corresponding to one or more intellectual property assets of an additional organization.

13. The system of any one of implementations 7-12, wherein the one or more valuation premises include: a liquidation premise that corresponds to a first predicted amount of revenue obtained by the organization with respect to a sale of at least a portion of the plurality of intellectual property assets in a scenario where the organization ceases operation; and a fair value premise that corresponds to a second predicted amount of revenue obtained by the organization with respect to at least a portion of the plurality of intellectual property assets in a scenario where the organization continues operation.

14 The system of any one of implementations 7-13, further comprising: the one or more computer-readable media storing additional instructions executable by the one or more processors, wherein the additional instructions, when executed by the one or more processors, cause the one or more processors to perform additional acts comprising: obtaining data from a plurality of data sources related to valuation of the plurality of intellectual property assets; storing at least a portion of the data according to a comma-separated values (CSV) format; and storing at least an additional portion of the data in association with one or more tags, the one or more tags corresponding to one or more factors included in a framework for performing a qualitative analysis of the plurality of intellectual property assets.

15. A method comprising: obtaining, by an intangible assets evaluation service, data from a plurality of data sources, the data corresponding to a plurality of intellectual property assets of an organization; determining, by the intangible assets evaluation service, a framework to perform a qualitative analysis of the plurality of intellectual property assets; identifying, by the intangible assets evaluation service and based at least partly on the framework, a first portion of the data for use in performing the qualitative analysis of the plurality of intellectual property assets; identifying, by the intangible assets evaluation service, a second portion of the data for use in performing a quantitative analysis of the plurality of intellectual property assets; performing, by the intangible assets evaluation service and based at least partly on the framework and the first portion of the data, the qualitative analysis of the plurality of intellectual property assets; and performing, by the intangible assets evaluation service and based at least partly on the second portion of the data, the quantitative analysis of the plurality of intellectual property assets.

16. The method of implementation 15, wherein: the framework includes one or more factors and one or more components corresponding to individual factors of the one or more factors; the one or more factors include a risk factor that corresponds to a probability that at least one intellectual property asset of the plurality of intellectual property assets will not contribute to an increase in a potential amount of revenue that may be obtained by the organization based on the plurality of intellectual property assets; a first component of the risk factor corresponds to litigation that includes at least one intellectual property asset of the plurality of intellectual property assets; and a second component of the risk factor corresponds to a probability of one or more intellectual property assets of the plurality of intellectual property assets being invalidated in a litigation proceeding or in an administrative proceeding.

17. The method of implementation 16, wherein: the framework includes one or more mitigating factors with respect to the risk factor; the one or more mitigating factors include a number of the plurality of intellectual property assets; and the method further comprises: modifying, by the intangible assets evaluation service, a metric corresponding to the risk factor based at least partly on the number of the plurality of intellectual property assets being greater than a threshold number.

18. The method of implementation 16 or 17, wherein: the framework includes a first set of weightings for individual factors of the one or more factors and a second set of weightings for individual components of the one or more components; and the first set of weightings and the second set of weightings is based at least partly on a type of data available to evaluate the one or more factors and the one or more components.

19. The method of any one of implementations 16-18, wherein: the type of data available to evaluate the risk factor includes a pending litigation that corresponds to at least one intellectual property asset of the plurality of intellectual property assets; and a weighting associated with the risk factor is based at least partly on the pending litigation that corresponds to at least one intellectual property asset of the plurality of intellectual property assets

20. The method of any one of implementations 16-19, wherein: the one or more factors include an opportunity factor that corresponds to a predicted increase in revenue of the organization attributable to the plurality of intellectual property assets; and the method further comprises: determining, by the intangible assets evaluation service, a first metric for the risk factor and a second metric for the opportunity factor based at least partly on the framework: and determining, by the intangible assets evaluation service, a combined metric based at least partly on the first metric and the second metric.

21. A system comprising: one or more processors, and one or more computer-readable media storing instructions executable by the one or more processors, wherein the instructions, when executed by the one or more processors, cause the one or more processors to perform acts comprising: obtaining data from a plurality of data sources, the data corresponding to a plurality of intangible assets of an organization; determining a framework to perform a qualitative analysis of the plurality of intangible assets; identifying, by the intangible assets evaluation service and based at least partly on the framework, a first portion of the data for use in performing the qualitative analysis of the plurality of intangible assets; identifying a second portion of the data for use in performing a quantitative analysis of the plurality of intangible assets; performing, based at least partly on the framework and the first portion of the data, the qualitative analysis of the plurality of intangible assets; and performing, based at least partly on the second portion of the data, the quantitative analysis of the plurality of intangible assets.

22. The system of implementation 21, wherein: the framework includes a plurality of factors and one or more components associated with individual factors of the plurality of factors; and the qualitative analysis includes a plurality of metrics, each of the plurality of metrics corresponding to an individual factor of the plurality of factors.

23. The system of implementation 22, wherein the plurality of metrics are based at least partly on at least one of: one or more first previous qualitative analyses corresponding to the plurality of intangible assets; and one or more second previous qualitative analyses corresponding to intangible assets of one or more additional organizations.

24. The system of any one of implementations 21-23, wherein the quantitative analysis of the plurality of intangible assets is based at least partly on the qualitative analysis of the plurality of intangible assets.

25. The system of any one of implementations 21-24, wherein: the plurality of intangible assets include intellectual property assets including at least one of patents, trademarks, copyrights, trade secrets, or know-how; and the plurality of factors include: coverage corresponding to a determined relationship between at least one of products or services of one or more organizations and the intellectual property assets; opportunity corresponding to a potential increase in the revenue of the organization attributable to the intellectual property assets; and risk corresponding to a potential that at least one intellectual property asset of the intellectual property assets contributes to a decrease in the opportunity.

26. The system of implementation 25, wherein: the intellectual property assets include a plurality of patents; and the framework includes: first components corresponding to the coverage, the first components including a strength of claims of one or more patents of the plurality of patents and a breadth of claims of the one or more patents of the plurality of patents; second components corresponding to the opportunity, the second components including a market size component corresponding to one or more products, one or more services, or both, that are associated with the claims of the one or more patents of the plurality of patents and including an alignment component corresponding to an amount of correlation between at least one product, at least one service, or both, offered by the organization and the claims of the one or more patents of the plurality of patents; and third components corresponding to the risk, the third components including a design around component related to an amount of changes to a product, a service, or both that result in the product, the service, or both, being non-infringing with respect to the claims of the one or more patents of the plurality of patents, an expiration component related to an amount of patent term remaining for individual patents of the plurality of patents; and an invalidity component related to a probability of at least one claim of the plurality of patents being invalidated in a litigation proceeding or an administrative proceeding.

27. The system of any one of implementations 21-24, wherein: the plurality of intangible assets include intellectual property assets including at least one of patents, trademarks, copyrights, trade secrets, or know-how; and the plurality of factors include: opportunity corresponding to a potential increase in the revenue of the organization attributable to the intellectual property assets and risk corresponding to a potential that at least one intellectual property asset of the intellectual property assets contributes to a decrease in the opportunity.

28. A method comprising: receiving, by an intangible assets evaluation service, information corresponding to a plurality of intellectual property assets; performing, by the intangible assets evaluation service, a first analysis of the plurality of intellectual property assets to determine a first metric indicating an opportunity related to the plurality of intellectual property assets, the opportunity corresponding to a potential increase in the revenue of the organization attributable to the plurality of intellectual property assets; performing, by the intangible assets evaluation service, a second analysis of the plurality of intellectual property assets to determine a second metric indicating a risk related to the plurality of intellectual property assets, the risk corresponding to a potential that at least one intellectual property asset of the plurality of intellectual property assets contributes to a decrease in the opportunity; generating, by the intangible assets evaluation service, a user interface that includes the first metric and the second metric; and causing, by the intangible assets evaluation service, the user interface to be displayed via a display device of a computing device.

29. The method of implementation 28, wherein: the first analysis includes evaluating first data obtained from a first plurality of data sources to determine the first metric; and the second analysis includes evaluating second data obtained from a second plurality of data sources to determine the second metric.

30. The method of implementation 29, further comprising: performing, based at least partly on the first analysis and additional first data, a first additional analysis of the plurality of intellectual property assets to determine a first additional metric indicating the opportunity, the additional first data being obtained from the first plurality of data sources subsequent to the first data; and performing, based at least partly on the second analysis and additional second data, a second additional analysis of the plurality of intellectual property assets to determine a second additional metric indicating the risk, the additional second data being obtained from the second plurality of data sources subsequent to the second data.

31. The method of implementation 28, further comprising: performing, based at least partly on the first analysis, a first additional analysis of a plurality of additional intellectual property assets of an additional organization to determine a first additional metric indicating an additional opportunity corresponding to a potential increase in revenue of the additional organization attributable to the plurality of additional intellectual property assets; and performing, based at least partly on the second analysis, a second additional analysis of the plurality of additional intellectual property assets to determine a second additional metric indicating an additional risk corresponding to a potential that at least one intellectual property asset of the plurality of additional intellectual property assets contributes to a decrease in the opportunity.

32. The method of any one of implementations 28-31, wherein: the method further comprises performing, by the intangible assets evaluation service and based at least partly on the first analysis and the second analysis, a quantitative analysis of the plurality of intellectual property assets to determine at least one monetary value of the plurality of intellectual property assets; and the quantitative analysis includes determining a monetary value of the plurality of intellectual property assets based on one or more valuation methodologies.

33. The method of any one of implementations 28-32, wherein the method further comprises: determining, by the intangible assets evaluation service, a framework by which to evaluate the plurality of intellectual property assets; and the framework includes a plurality of factors and one or more components associated with individual factors of the plurality of factors.

34. The method of implementation 33, further comprising performing, based at least partly on the framework: a first qualitative analysis of a plurality of patent assets; a second qualitative analysis of a plurality of trade secret assets; a third qualitative analysis of a plurality of trademark assets; and a fourth qualitative analysis of a plurality of copyright assets.

What is claimed is:

1. A system comprising:
one or more processors; and
one or more computer-readable media storing instructions executable by the one or more processors, wherein the instructions, when executed by the one or more processors, cause the one or more processors to perform acts comprising:
obtaining data from a plurality of data sources, the data corresponding to a plurality of intangible assets of an organization;
determining a framework to perform a qualitative analysis of the plurality of intangible assets;
identifying, based at least partly on the framework, a first portion of the data for use in performing the qualitative analysis of the plurality of intangible assets:
identifying a second portion of the data for use in performing a quantitative analysis of the plurality of intangible assets;
performing, based at least partly on the framework and the first portion of the data, the qualitative analysis of the plurality of intangible assets; and
performing, based at least partly on the second portion of the data, the quantitative analysis of the plurality of intangible assets.

2. The system of claim 1, wherein:
the framework includes a plurality of factors and one or more components associated with individual factors of the plurality of factors; and
the qualitative analysis includes a plurality of metrics, each of the plurality of metrics corresponding to an individual factor of the plurality of factors.

3. The system of claim 2, wherein the plurality of metrics are based at least partly on at least one of:
one or more first previous qualitative analyses corresponding to the plurality of intangible assets; and
one or more second previous qualitative analyses corresponding to intangible assets of one or more additional organizations.

4. The system of claim 1, wherein the quantitative analysis of the plurality of intangible assets is based at least partly on the qualitative analysis of the plurality of intangible assets.

5. The system of claim 1, wherein:
the plurality of intangible assets include intellectual property assets including at least one of patents, trademarks, copyrights, trade secrets, or know-how; and
the plurality of factors include:
coverage corresponding to a determined relationship between at least one of products or services of one or more organizations and the intellectual property assets;
opportunity corresponding to a potential increase in revenue of the organization attributable to the intellectual property assets; and
risk corresponding to a potential that at least one intellectual property asset of the intellectual property assets contributes to a decrease in the opportunity.

6. The system of claim 5, wherein:
the intellectual property assets include a plurality of patents; and
the framework includes:
first components corresponding to the coverage, the first components including a strength of claims of one or more patents of the plurality of patents and a breadth of claims of the one or more patents of the plurality of patents;
second components corresponding to the opportunity, the second components including a market size component corresponding to one or more products, one or more services, or both, that are associated with the claims of the one or more patents of the plurality of patents and including an alignment component corresponding to an amount of correlation between at least one product, at least one service, or both, offered by the organization and the claims of the one or more patents of the plurality of patents; and
third components corresponding to the risk, the third components including a design around component related to an amount of changes to a product, a service, or both that result in the product, the service, or both, being non-infringing with respect to the claims of the one or more patents of the plurality of patents, an expiration component related to an amount of patent term remaining for individual patents of the plurality of patents; and
an invalidity component related to a probability of at least one claim of the plurality of patents being invalidated in a litigation proceeding or an administrative proceeding.

7. The system of claim 1, wherein the plurality of intangible assets include intellectual property assets including at least one of patents, trademarks, copyrights, trade secrets, or know-how; and the plurality of factors include:
opportunity corresponding to a potential increase in revenue of the organization attributable to the intellectual property assets; and
risk corresponding to a potential that at least one intellectual property asset of the intellectual property assets contributes to a decrease in the opportunity.

8. A method comprising:
obtaining, by an intangible assets evaluation service, data from a plurality of data sources, the data corresponding to a plurality of intellectual property assets of an organization;
determining, by the intangible assets evaluation service, a framework to perform a qualitative analysis of the plurality of intellectual property assets;
identifying, by the intangible assets evaluation service and based at least partly on the framework, a first portion of the data for use in performing the qualitative analysis of the plurality of intellectual property assets;
identifying, by the intangible assets evaluation service, a second portion of the data for use in performing a quantitative analysis of the plurality of intellectual property assets;
performing, by the intangible assets evaluation service and based at least partly on the framework and the first portion of the data, the qualitative analysis of the plurality of intellectual property assets; and
performing, by the intangible assets evaluation service and based at least partly on the second portion of the data, the quantitative analysis of the plurality of intellectual property assets.

9. The method of claim 8, wherein:
the framework includes one or more factors and one or more components corresponding to individual factors of the one or more factors;
the one or more factors include a risk factor that corresponds to a probability that at least one intellectual property asset of the plurality of intellectual property assets will not contribute to an increase in a potential amount of revenue that may be obtained by the organization based on the plurality of intellectual property assets;
a first component of the risk factor corresponds to litigation that includes at least one intellectual property asset of the plurality of intellectual property assets; and
a second component of the risk factor corresponds to a probability of one or more intellectual property assets of the plurality of intellectual property assets being invalidated in a litigation proceeding or in an administrative proceeding.

10. The method of claim 9, wherein:
the framework includes one or more mitigating factors with respect to the risk factor;
the one or more mitigating factors include a number of the plurality of intellectual property assets; and
the method further comprises modifying, by the intangible assets evaluation service, a metric corresponding to the risk factor based at least partly on the number of the plurality of intellectual property assets being greater than a threshold number.

11. The method of claim 9, wherein:
the framework includes a first set of weightings for individual factors of the one or more factors and a second set of weightings for individual components of the one or more components; and
the first set of weightings and the second set of weightings is based at least partly on a type of data available to evaluate the one or more factors and the one or more components.

12. The method of claim 9, wherein:
the type of data available to evaluate the risk factor includes a pending litigation that corresponds to at least one intellectual property asset of the plurality of intellectual property assets; and
a weighting associated with the risk factor is based at least partly on the pending litigation that corresponds to at least one intellectual property asset of the plurality of intellectual property assets

13. The method of claim 9, wherein:
the one or more factors include an opportunity factor that corresponds to a predicted increase in revenue of the organization attributable to the plurality of intellectual property assets; and
the method further comprises:
determining, by the intangible assets evaluation service, a first metric for the risk factor and a second metric for the opportunity factor based at least partly on the framework; and
determining, by the intangible assets evaluation service, a combined metric based at least partly on the first metric and the second metric.

14. A method comprising:
receiving, by an intangible assets evaluation service, information corresponding to a plurality of intellectual property assets;
performing, by the intangible assets evaluation service, a first analysis of the plurality of intellectual property assets to determine a first metric indicating an opportunity related to the plurality of intellectual property assets, the opportunity corresponding to a potential increase in the revenue of the organization attributable to the plurality of intellectual property assets;
performing, by the intangible assets evaluation service, a second analysis of the plurality of intellectual property assets to determine a second metric indicating a risk related to the plurality of intellectual property assets, the risk corresponding to a potential that at least one intellectual property asset of the plurality of intellectual property assets contributes to a decrease in the opportunity;
generating, by the intangible assets evaluation service, a user interface that includes the first metric and the second metric; and
causing, by the intangible assets evaluation service, the user interface to be displayed via a display device of a computing device.

15. The method of claim 14, wherein:
the first analysis includes evaluating first data obtained from a first plurality of data sources to determine the first metric; and
the second analysis includes evaluating second data obtained from a second plurality of data sources to determine the second metric.

16. The method of claim 15, further comprising:
performing, based at least partly on the first analysis and additional first data, a first additional analysis of the plurality of intellectual property assets to determine a first additional metric indicating the opportunity, the additional first data being obtained from the first plurality of data sources subsequent to the first data; and
performing, based at least partly on the second analysis and additional second data, a second additional analysis of the plurality of intellectual property assets to determine a second additional metric indicating the risk, the additional second data being obtained from the second plurality of data sources subsequent to the second data.

17. The method of claim 14, further comprising:
performing, based at least partly on the first analysis, a first additional analysis of a plurality of additional intellectual property assets of an additional organization to determine a first additional metric indicating an additional opportunity corresponding to a potential increase in revenue of the additional organization attributable to the plurality of additional intellectual property assets; and
performing, based at least partly on the second analysis, a second additional analysis of the plurality of additional intellectual property assets to determine a second additional metric indicating an additional risk corresponding to a potential that at least one intellectual property asset of the plurality of additional intellectual property assets contributes to a decrease in the opportunity.

18. The method of claim 14, wherein:
the method further comprises performing, by the intangible assets evaluation service and based at least partly on the first analysis and the second analysis, a quantitative analysis of the plurality of intellectual property assets to determine at least one monetary value of the plurality of intellectual property assets; and
the quantitative analysis includes determining a monetary value of the plurality of intellectual property assets based on one or more valuation methodologies.

19. The method of claim 14, further comprising:
determining, by the intangible assets evaluation service, a framework by which to evaluate the plurality of intellectual property assets; and
the framework includes a plurality of factors and one or more components associated with individual factors of the plurality of factors.

20. The method of claim 19, further comprising performing, based at least partly on the framework:
a first qualitative analysis of a plurality of patent assets;
a second qualitative analysis of a plurality of trade secret assets;
a third qualitative analysis of a plurality of trademark assets; and
a fourth qualitative analysis of a plurality of copyright assets.
